(19) United States
(12) Patent Application Publication
(10) Pub. No.: US 2026/0168275 A1
(43) Pub. Date: Jun. 18, 2026

(54) POOL CLEANING SYSTEM

(71) Applicant: WYBOTICS Co., LTD., Tianjin (CN)

(72) Inventors: Qian YU, Tianjin (CN); Pu CEN, Tianjin (CN); Xinming TONG, Tianjin (CN); Youjiang WANG, Tianjin (CN)

(21) Appl. No.: 19/532,700

(22) Filed: Feb. 6, 2026

Related U.S. Application Data
(63) Continuation of application No. PCT/CN2025/092865, filed on May 6, 2025.

(30) Foreign Application Priority Data
May 9, 2024 (CN) 202410570492.1
Aug. 2, 2024 (CN) 202421874856.7
Sep. 30, 2024 (CN) 202411386847.8
Oct. 29, 2024 (CN) 202411522053.X
Oct. 29, 2024 (CN) 202422622885.0
Nov. 29, 2024 (CN) 202422943366.4

(51) Int. Cl. E04H 4/16; B01D 29/72; B01D 35/143; C02F 1/00; C02F 1/50; C02F 1/68; C02F 103/42; G01F 22/00; H02S 99/00

(52) U.S. Cl. CPC E04H 4/1654; B01D 29/72; B01D 35/143; C02F 1/001; C02F 1/008; C02F 1/50; C02F 1/685; G01F 22/00; C02F 2103/42; C02F 2209/02; C02F 2209/06; C02F 2209/11; C02F 2303/04; C02F 2303/16; H02S 99/00

(57) ABSTRACT

A pool cleaning system is provided. The pool cleaning system includes a base station and a pool cleaning robot. The pool cleaning robot is provided with a filtering device and is separable from the base station. In a case where the pool cleaning robot is separated from the base station, a liquid in a pool is filtered by the filtering device.

### CROSS-REFERENCE TO RELATED APPLICATIONS

The present application is a continuation of International Application No. PCT/CN2025/092865 filed on May 6, 2025, which claims priority to Chinese Patent Application No. 202410570492.1 filed on May 9, 2024, to, Chinese Patent Application No. 202411522053.X filed on Oct. 29, 2024, to Chinese Patent Application No. 202411386847.8 filed on Sep. 30, 2024, to Chinese Patent Application No. 202422622885.0 filed on Oct. 29, 2024, to Chinese Patent Application No. 202421874856.7 filed on Aug. 2, 2024, and to Chinese Patent Application No. 202422943366.4 filed on Nov. 29, 2024, the entire contents of which are incorporated herein by reference.

### TECHNICAL FIELD

The present application relates to the technical field of pool cleaning, and in particular, to a pool cleaning system.

### BACKGROUND

Swimming pools, reservoirs, artificial fountains, and other pools accumulate a large amount of dirt inside after long-term use, and need to be cleaned periodically.

In related technologies, the interiors of these pools are cleaned manually. However, this pool cleaning method is time-consuming and labor-intensive, resulting in lower pool cleaning efficiency and high labor costs.

### SUMMARY

Embodiments of the present application provide a pool cleaning system, which can solve the problems of lower pool cleaning efficiency and high labor costs.

The embodiments of the present application provide a pool cleaning system, including a base station and a pool cleaning robot. The pool cleaning robot is provided with a filtering device and is separable from the base station. In a case where the pool cleaning robot is separated from the base station, a liquid in the pool is filtered by the filtering device.

In the embodiments of the present application, the filtering device is disposed inside the pool cleaning robot. After the pool cleaning robot is separated from the base station, the filtering device may automatically clean dirt in the pool during the cleaning operation of the pool, thereby effectively cleaning the pool, and effectively reducing labor costs.

### BRIEF DESCRIPTION OF THE DRAWINGS

FIG. 1 is a first schematic structural diagram of a pool cleaning system according to embodiments of the present application.

FIG. 2 is a second schematic structural diagram of a pool cleaning system according to the embodiments of the present application.

FIG. 3 is a schematic structural diagram of a base station according to the embodiments of the present application.

FIG. 4 is schematic diagram showing a connection between a base station and a pool cleaning robot of a pool cleaning system according to the embodiments of the present application.

FIG. 5 is a schematic structural diagram of a pool cleaning system according to an embodiment of the present application.

FIG. 6 is a schematic structural diagram of a base station and a sewage suction device according to an embodiment of the present application.

FIG. 7 is a schematic structural diagram of a pool cleaning robot according to an embodiment of the present application.

FIG. 8 is a sectional view of a pool cleaning system according to an embodiment of the present application.

FIG. 9 is a schematic structural diagram of a filtering device according to an embodiment of the present application;

FIG. 10 is a schematic sectional view of a filtering device according to an embodiment of the present application.

FIG. 11 is a partial schematic structural diagram of a sewage suction device according to another embodiment of the present application.

FIG. 12 is a schematic structural diagram of a collection container according to an embodiment of the present application.

FIG. 13 is a schematic structural diagram of a flushing device according to an embodiment of the present application.

FIG. 14 is a partial schematic diagram of a sewage suction pump according to an embodiment of the present application.

FIG. 15 is a schematic structural diagram of a pool cleaning robot according to an embodiment of the present application.

FIG. 16 is a schematic exploded view of a pool cleaning robot according to an embodiment of the present application.

FIG. 17 is a schematic structural diagram of a flushing device according to an embodiment of the present application.

FIG. 18 is a schematic structural diagram of a flushing device according to another embodiment of the present application.

FIG. 19 is a schematic structural diagram of a flushing device from another perspective according to another embodiment of the present application.

FIG. 20 is a schematic structural diagram of a fixing device according to an embodiment of the present application.

FIG. 21 is a schematic structural diagram of a fixing device according to another embodiment of the present application.

FIG. 22 is a schematic structural diagram of a fixing device according to another embodiment of the present application.

FIG. 23 is a schematic front view of the fixing device shown in FIG. 22.

FIG. 24 is a schematic side view of the fixing device as shown in FIG. 22.

FIG. 25 is a schematic structural diagram of a fixing device according to another embodiment of the present application.

FIG. 26 is a schematic cross-sectional view of a counterweight assembly shown in FIG. 25.

FIG. 27 is a schematic diagram of the fixing device shown in FIG. 25 from another perspective.

FIG. 28 is a partial schematic structural diagram of the fixing device shown in FIG. 27 (with a bottom shell and a connecting shaft assembly hidden).

FIG. 29 is a schematic structural diagram of a connecting shaft assembly.

FIG. 30 is a schematic structural diagram of a pool cleaning system according to an embodiment of the present application.

FIG. 31 is a schematic front view of the fixing device shown in FIG. 30.

FIG. 32 is a schematic side view of the fixing device shown in FIG. 30.

FIG. 33 is a schematic structural diagram of a fixing device according to an embodiment of the present application.

FIG. 34 is a schematic diagram of a fixing device according to another embodiment of the present application.

FIG. 35 is a schematic diagram showing a connection between a fixing device and a first part according to an embodiment of the present application.

FIG. 36 is a schematic cross-sectional view of the first part in FIG. 35.

FIG. 37 is a schematic diagram of a structure shown in FIG. 35 from another perspective.

FIG. 38 is a partial schematic structural diagram of the structure shown in FIG. 37 (with a bottom shell and a connecting shaft assembly hidden).

FIG. 39 is a schematic structural diagram of a connecting shaft assembly according to an embodiment of the present application.

FIG. 40 is a schematic diagram when a pool cleaning robot and a base station are connected (with a filtering device in an installation state) according to an embodiment of the present application.

FIG. 41 is a schematic diagram when a pool cleaning robot and a base station are connected (with a filtering device in a withdrawn state) according to an embodiment of the present application.

FIG. 42 is a schematic diagram when a base station and a fixing device are connected according to an embodiment of the present application.

FIG. 43 is a schematic diagram showing a connection position between a base station and a fixing device according to an embodiment of the present application.

### REFERENCE NUMERALS IN DRAWINGS

1—Pool cleaning system;
100—Base station; 108—Docking port I; 109—Sealing element;
110—First part; 101—Outer shell; 1011—Bottom shell; 1012—Upper shell; 102—Counterweight; 103—Solar panel; 105—First surface; 107—Elastic element;
120—Second part; 121—Second surface;
130—Energy storage device; 131—Photovoltaic charging device;
140—First charging device; 150—Control panel; 160—First signal device; 170—Sewage suction docking port; 180—First sensor; 190—Controller;
1100—Garbage collection device;
111—Collection container; 1111—Container body; 1112—inlet; 1113—Water return structure; 1114—Accommodating device;
112—Sewage suction pump; 1121—Water flow guider;
113—Sewage suction pipeline;
114—Water return passage;
115—Connecting pipeline;
116—Filtering equipment;
200—Pool cleaning robot;
210—Robot body; 211—Docking port II; 212—Robot body outlet; 213—Installation cavity; 214—Water inlet; 215—Water outlet; 216-Limiting protrusion;
220—Filtering device;
221—Housing;
225—Second charging device;
226—Second signal device;
227—Third sensor;
228—Sewage accommodating space I; 2281—Slope;
229—Flow channel;
2210—First flow channel wall; 22101—Third segment; 22102—Fourth segment;
2211—Second flow channel wall;
230—Pump assembly; 231—Motor; 232—Impeller;
240—Cover plate; 241—Plate main body; 242—Protrusion;
250—Flushing device;
251—Installation baffle; 2511—Water passage hole; 2512—Baffle body; 2513—Installation portion;
252—Nozzle; 2521—Drain hole;
253—Unidirectional mechanism; 2531—Water baffle;
260—Locking mechanism;
300—Pool bank;
400—Side wall;
500—Fixing device; 501—Limiter;
510—Connecting member; 511—First connecting portion; 5111—First abutting surface; 512—Extension portion; 513—Second connecting portion; 5131—Second abutting surface; 5132—Hook; 514—Reinforcement rib;
520—Counterweight assembly; 521—Counterweight plate; 522—Outer shell; 5221—Bottom shell; 5222—Upper shell;
530—Solar panel;
540—Connecting shaft assembly; 541—Rotating shaft; 542—Shaft seat; 5421—Seat body; 5422—Elastic arm; 543—Adjusting member; 5431—Adjusting wrench; 54311—Pressing portion; 54312—Handle; 54313—Installation portion; 5432—Connecting column;
550—Elastic element;
560—Articulated shaft;
570—Adjusting hole; and 571—Adjusting bolt.

### DETAILED DESCRIPTION OF THE EMBODIMENTS

In order to make the objectives, technical solutions and advantages of the present application clearer, the present application will be further described here with reference to the accompanying drawings and embodiments. It should be understood that the specific embodiments described herein are only intended to illustrate but not to limit the present application.

Embodiments of the present application provide a pool cleaning system, including a base station disposed on a pool wall and a pool cleaning robot capable of docking with the base station. The pool cleaning robot is provided with a filtering device and is separable from the base station. In a case where the pool cleaning robot is separated from the base station, a liquid in a pool is filtered by the filtering device.

In the embodiments of the present application, the filtering device is disposed inside the pool cleaning robot. After the pool cleaning robot is separated from the base station, the filtering device may automatically clean dirt in the pool during the cleaning operation of the pool, thereby effectively cleaning the pool and effectively reducing labor costs.

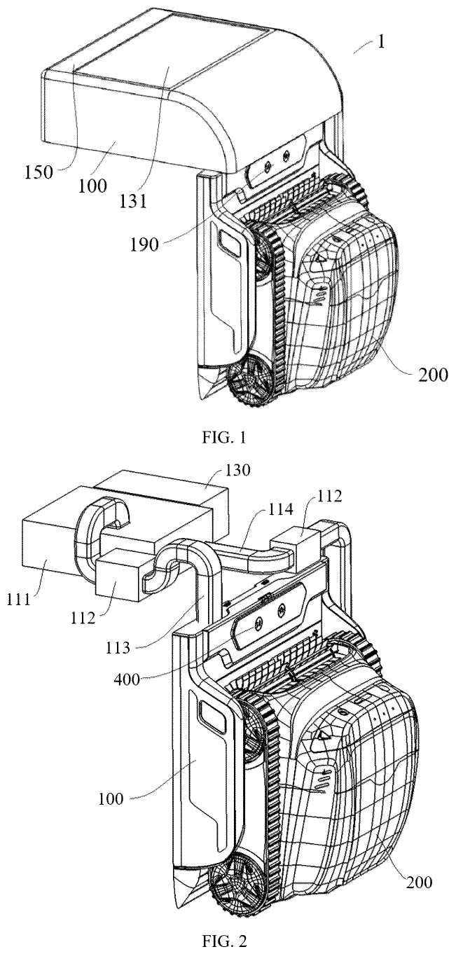

As shown in FIG. 1 to FIG. 4, the base station 100 is provided with a garbage collection device 1100. In a case where the pool cleaning robot 200 is connected to the base station 100, garbage in the filtering device 220 is collected into the garbage collection device 1100. At least part of the base station is located above water. The pool cleaning robot 200 is capable of docking with the base station 100 adjacent to a waterline. In a case where the pool cleaning robot 200 is connected to the base station 100, the pool cleaning robot 200 is in a vertical or substantially vertical state.

When the pool cleaning robot 200 operates in the pool, the filtering device 220 can continuously collect garbage in the pool. When the filtering device 220 is filled or nearly filled with garbage, the pool cleaning robot 200 moves toward the base station 100 and is connected to the base station 100, and the garbage collection device 1100 can collect the garbage in the filtering device 220 so that the amount of the garbage in the filtering device 220 is reduced. Then, the pool cleaning robot 200 is separated from the base station 100 and continues to operate in the pool, and the filtering device 220 continues to collect the garbage in the pool, resulting in a long single operation time for the pool cleaning robot 200 in the pool.

In this way, the pool cleaning system 1 can automatically collect the garbage inside the filtering device 220 of the pool cleaning robot 200 by means of the garbage collection device 1100. This extends a single operation duration of the pool cleaning robot 200 without requiring a user to manually collect the garbage in the filtering device 220, thereby enabling better usage experience of the user.

For example, the filtering device 220 includes a filter mesh which is connected to a vibration device. The vibration device is configured to vibrate the filter mesh. The vibration device may be a device capable of driving an object to vibrate, such as an ultrasonic oscillator, a vibration motor. In a case where a liquid in the pool enters the filtering device 220, the filter mesh may intercept garbage in the liquid, while allowing the liquid to flow back into the pool from the filter mesh. In this process, some garbage may get stuck on the filter mesh. Therefore, when the pool cleaning robot 200 is connected to the base station 100, the vibration device can drive the filter mesh to vibrate, shaking off the garbage from the filter mesh, ensuring that most of the garbage in the filtering device 220 is collected into the garbage collection device 1100, and reducing the amount of remaining garbage in the filtering device 220.

In addition, in a case where the pool cleaning robot 200 is separated from the base station 100, the vibration device may also drive the filter mesh to vibrate, shaking off the garbage from the filter mesh. This ensures that the water flow area of the filter mesh is restored to its maximum, improving water flow efficiency and preventing the garbage from overflowing into the pool due to water accumulation in the filtering device 220.

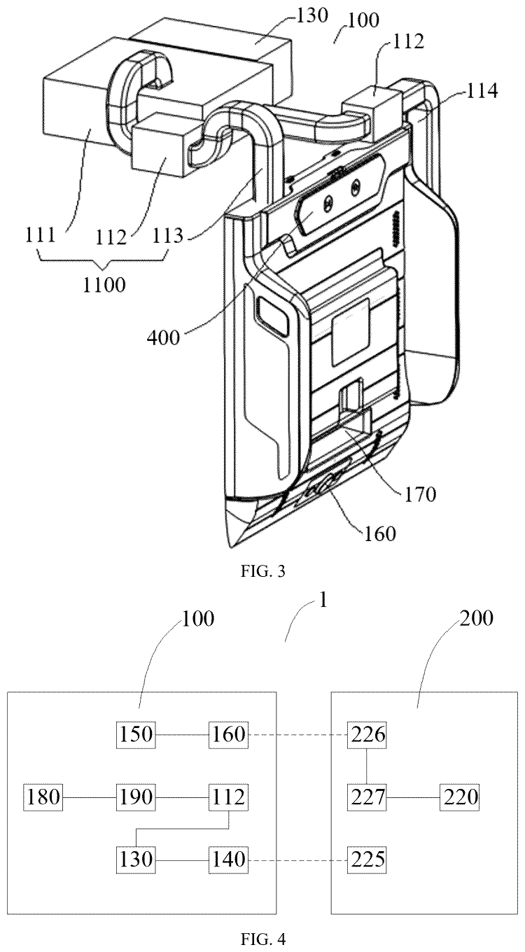

In some embodiments of the present application, as shown in FIG. 3, the base station 100 may be provided with a sewage suction docking port 170. When the pool cleaning robot 200 is connected to the base station 100, the sewage suction docking port 170 docks with an outlet of the filtering device 220. The sewage suction docking port 170 can be inserted into the filtering device 220, or the filtering device 220 is inserted into the sewage suction docking port 170 to improve the sealing performance and reduce the risk of garbage leakage.

As shown in FIG. 2 and FIG. 3, the above garbage collection device 1100 includes a collection container 111 and a sewage suction pump 112. In a case where the pool cleaning robot 200 is connected to the base station 100, the collection container 111 is fluidly communicated with the filtering device 220. In a case where the pool cleaning robot 200 is connected to the base station 100, the sewage suction pump 112 operates to suck the garbage in the filtering device 220 into the collection container 111, and/or the sewage suction pipeline 113 communicates with the bottom of the pool cleaning robot 200.

By arranging the sewage suction pump 112, the garbage in the filtering device 220 can be conveniently sucked into the collection container 111. In addition, in a case where the pool cleaning robot 200 is connected to the base station 100, the sewage suction pump 112 starts operating. In a case where the pool cleaning robot 200 is separated from the base station 100, the sewage suction pump 112 stops operating. This can reduce energy consumption and lower usage costs.

The above collection container 111 is separably connected to the base station 100. In other words, the collection container 111 can be pulled out from the base station 100 and can also be pushed into the base station 100. In this way, when the garbage stored in the collection container 111 reaches a certain level, the collection container 111 can be pulled out from the base station 100, so that the collection container 111 is separated from the base station 100, making it easier to empty the garbage in the collection container 111 and clean the collection container 111.

As shown in FIG. 2 and FIG. 3, the above garbage collection device 1100 further includes a sewage suction pipeline 113 which is connected to the collection container 111. In a case where the pool cleaning robot 200 is connected to the base station 100, the sewage suction pipeline 113 is fluidly communicated with the filtering device 220. The cross-sectional area of the sewage suction pipeline 113 may be smaller than that of the collection container 111. This not only enables a fluid communication between the collection container 111 and the filtering device 220, but also provides more space for the collection container 111 to store more garbage due to the larger cross-sectional area of the collection container 111. Further, the space occupied by the garbage collection device 1100 can be reduced due to the smaller cross-sectional area of the sewage suction pipeline 113, thereby reducing the volume of the base station 100.

Further, a plurality of sewage suction pipelines 113 may be arranged and are provided with respective sewage suction pumps 112. The plurality of sewage suction pumps 112 may be started and stopped synchronously, which reduces operation difficulty and improves usage convenience. Alternatively, the plurality of sewage suction pumps 112 may be started and stopped separately, meaning that the start and stop of each sewage suction pump 112 is not affected by another sewage suction pump 112. This allows the number of the sewage suction pumps 112 that are started to increase in a case with a large amount of garbage, and decrease in a case with a small amount of garbage, thereby reducing energy consumption.

In addition, the plurality of sewage suction pipelines 113 can provide redundancy to prevent blockage in one pipeline from affecting the overall usage performance of the pool cleaning system 1.

As shown in FIG. 2 and FIG. 3, the above garbage collection device 1100 further includes a water return passage 114. A top end of the water return passage 114 is connected to the collection container 111, and the water return passage 114 is configured to discharge the liquid filtered by the collection container 111 to the pool. The water return passage 114 may be provided with a sewage suction pump 112 to accelerate the discharge of the liquid in the garbage collection device 1100.

By arranging the water return passage 114, water accumulation in the collection container 111 can be avoided, and the garbage in the collection container 111 can be prevented from being carried out by accumulated water, thereby reducing the resistance for the garbage to enter the collection container 111, and reducing the probability of bacterial growth within the garbage in the collection container 111.

For example, the water return passage 114 may be connected to a lower area of the collection container 111 to reduce the amount of residual liquid in the collection container 111. The sewage suction pipeline 113 may be connected to an upper area of the collection container 111 to prevent the garbage in the collection container 111 from flowing back to the sewage suction pipeline 113, thereby reducing the probability of garbage leakage.

In addition, a water return filter mesh may be disposed at a water inlet of the water return passage 114 to filter liquid flowing into the water return passage 114, thereby improving the cleanliness of the pool.

As shown in FIG. 1 to FIG. 3, the above base station 100 is further provided with an energy storage device 130 which supplies power to the sewage suction pump 112. The energy storage device 130 may include a storage battery or a photovoltaic charging device 131. This means that the base station 100 does not need to be continuously charged via a wire during use, making the use of the base station 100 more convenient, and extending the operation duration of the base station 100. Moreover, the energy storage device 130 may be detached from the base station 100 and moved elsewhere for charging, making the charging of the energy storage device 130 more flexible.

As shown in FIG. 1, the above energy storage device 130 includes a charging device 131. This enables the energy storage device 130 to constantly convert solar energy into electric energy and continuously supply power to the sewage suction pump 112, thereby extending the operation duration of the sewage suction pump 112.

In some embodiments of the present application, at least part of the base station 100 is located above a liquid level 310 of the liquid. The photovoltaic charging device 131 is disposed on a part of the base station 100 above the liquid level 310 of the liquid, enabling higher sunlight exposure efficiency of the photovoltaic charging device 131. Therefore, the endurance of the base station 100 is stronger, and the risk that the photovoltaic charging device 131 is short-circuited is also reduced.

In some other embodiments of the present application, at least part of the photovoltaic charging device 131 is located below the liquid level 310 of the liquid, and the part of the photovoltaic charging device 131 located below the liquid level 310 of the liquid is provided with a waterproof structure. In this way, the photovoltaic charging device 131 can be installed at a lower position, so that the photovoltaic charging device 131 can be more flexibly installed on the base station 100. In addition, the photovoltaic charging device 131 can also be prevented from being short-circuited due to the arrangement of the waterproof structure.

As shown in FIG. 4, the above base station 100 is further provided with a first charging device 140 which is connected to the energy storage device 130. The pool cleaning robot is provided with a second charging device 225. In a case where the pool cleaning robot 200 is connected to the base station 100, the first charging device 140 and the second charging device 225 are connected.

For example, the first charging device 140 may be a plug, the second charging device 225 may be a socket, and the first charging device 140 and the second charging device 225 may be connected in a plug-and-play manner, or use wireless charging, such as electromagnetic charging.

Through the connection between the first charging device 140 and the second charging device 225, the energy storage device 130 can charge the pool cleaning robot 200. This enables the pool cleaning robot 200 to be automatically charged in the pool cleaning system 1, relieving the user from constantly monitoring the power level of the pool cleaning robot 200, which helps extend the single operation duration of the pool cleaning robot 200.

As shown in FIG. 3, the pool cleaning system 1 further includes a first sensor 180 which is disposed on the base station 100 and connected to the sewage suction pump 112. The first sensor 180 is configured to detect whether the pool cleaning robot 200 is connected to the base station 100. The sewage suction pump 112 is started or stopped based on a signal from the first sensor 180.

The first sensor 180 may be a pressure sensor, and in a case where the pool cleaning robot 200 is connected to the base station 100, the pool cleaning robot 200 presses the first sensor 180. Alternatively, the first sensor 180 may be an optical sensor, and in a case where the pool cleaning robot 200 is connected to the base station 100, the pool cleaning robot 200 blocks the first sensor 180.

For example, in a case where the first sensor 180 detects that the pool cleaning robot 200 is connected to the base station 100, a controller 190 controls the sewage suction pump 112 to start. In a case where the first sensor 180 detects that the pool cleaning robot 200 is separated from the base station 100, the controller 190 controls the sewage suction pump 112 to stop.

The start of the sewage suction pump 112 when the pool cleaning robot 200 is separated from the base station 100 not only makes it unable to collect the garbage in the filtering device 220 to the garbage collection device 1100, but also may cause the liquid in the pool to be sucked into the garbage collection device 1100, which may lead to the overflow of the garbage in the garbage collection device 1100. Therefore, in the present application, the arrangement of the first sensor 180 and the controller 190 can ensure that the garbage of the filtering device 220 is sucked when the sewage suction pump 112 is started, thereby not only improving working efficiency but also avoiding the overflow of the garbage in the garbage collection device 1100.

In some embodiments of the present application, the base station 100 may be provided with a second sensor (not shown in drawings). The second sensor is configured to detect the volume of the garbage in the collection container 111. The second sensor may be connected to an alarm device (such as a buzzer or a flashing light), a control panel 150 of the base station 100, a mobile terminal, or other structures, and is configured to alert the user when the collection container 111 is filled with garbage, reminding the user to clean the collection container 111 in time and preventing excessive accumulation of the garbage in the collection container 111.

In some embodiments of the present application, the pool cleaning robot 200 is provided with a third sensor 227 which is configured to detect the volume of the garbage in the filtering device 220. For example, the third sensor 227 may check the height and volume of the garbage in the filtering device 220, or the amount of the liquid in the filtering device 220, thereby determining the volume of the garbage in the filtering device 220.

By the arrangement of the third sensor 227, it can be detected whether the amount of the garbage in the filtering device 220 reaches a preset value. The third sensor 227 feeds back a detection result to the alarm device (such as the buzzer or the flashing light), the control panel 150 of the base station 100, the mobile terminal or the other structures, and is configured to alert the user when the filtering device 220 is filled with garbage, reminding the user to clean the filtering device 220 in time and preventing excessive accumulation of the garbage in the filtering device 220.

As shown in FIG. 4, the above base station 100 is further provided with the control panel 150 and a first signal device 160. The control panel 150 and the first signal device 160 are connected. The pool cleaning robot 200 is further provided with a second signal device 226. The third sensor 227 and the second signal device 226 are connected. The first signal device 160 and the second signal device 226 are in wireless or wired communication.

The first signal device 160 and the second signal device 226 may communicate with each other through an optical signal or an acoustic signal. This eliminates the need for a wire, making the movement of the pool cleaning robot 200 more flexible, and eliminating the risk of wire wear.

For example, the control panel 150 may display the current state of the pool cleaning robot, such as the power level and the position of the pool cleaning robot. The control panel 150 may also display the current state of the base station 100, such as the power level of the base station 100 and the current garbage amount in the garbage collection device 1100.

The user may operate the control panel 150, and the control panel 150 transmits a control signal to the pool cleaning robot 200 through the first signal device 160 and the second signal device 226 so as to control separation and connection between the pool cleaning robot 200 and the base station 100, making it more convenient for the user to operate the pool cleaning robot 200.

The third sensor 227 feeds back the detection result to the second signal device 226, and then the second signal device 226 feeds back the detection result to the first signal device 160. The control panel 150 can display the garbage storage state in the filtering device 220. For example, the control panel 150 can display whether the filtering device 220 is filled with garbage, or a percentage of the current garbage amount in the filtering device 220 relative to the total capacity of the filtering device 220. The user may actively control, based on the display result of the control panel 150, whether the pool cleaning robot 200 is connected to the base station 100.

For example, when the control panel 150 displays that the filtering device 220 is filled with garbage, the user controls the pool cleaning robot 200 to connect to the base station 100. Alternatively, when the control panel 150 displays that the percentage of the current garbage amount in the filtering device 220 relative to the total capacity of the filtering device 220 is 80% or more, the user controls the pool cleaning robot 200 to connect to the base station 100.

In this way, the control panel 150 can display the current garbage amount in the filtering device 220 in real time, and the user can learn the current garbage amount in the filtering device 220 in real time, to determine whether the pool cleaning robot 200 needs to be connected to the base station 100. This not only facilitates timely collection of the garbage from the filtering device 220 into the garbage collection device 1100, but also enables the user to better manage his/her time.

In some embodiments of the present application, as shown in FIG. 1 to FIG. 4, the pool cleaning system 1 includes a controller 190. The controller 190 controls the connection and separation between the pool cleaning robot 200 and the base station 100 based on a signal from the third sensor 227. The controller 190 is installed on the pool cleaning robot 200 and connected to the third sensor 227.

The third sensor 227 feeds back the detection result to the controller 190. When the amount of the garbage in the filtering device 220 reaches the preset value, the controller 190 controls the pool cleaning robot 200 to connect to the base station 100.

In other embodiments of the present application, the pool cleaning system 1 includes a controller 190. The controller 190 controls the connection and separation between the pool cleaning robot 200 and the base station 100 based on the signal from the third sensor 227. The controller 190 is installed on the base station 100 and connected to the first signal device 160. The controller 190 is configured to control the connection and separation between the pool cleaning robot 200 and the base station 100.

The third sensor 227 feeds back the detection result to the second signal device 226, and then the second signal device 226 feeds back the detection result to the first signal device 160. In a case where the amount of the garbage in the filtering device 220 reaches the preset value, the controller 190 transmits a control signal to the second signal device 226 through the first signal device 160 so as to control the pool cleaning robot 200 to connect to the base station 100.

In this way, the pool cleaning system 1 can control the pool cleaning robot 200 to automatically move to the base station 100 based on the volume of the garbage in the filtering device 220, thereby improving the automation level of the pool cleaning system 1. This helps ensure that in a case where the filtering device 220 of the pool cleaning robot 200 is filled with garbage, the pool cleaning robot 200 is controlled in time to connect to the base station 100, thereby collecting the garbage in the filtering device 220 into the garbage collection device 1100.

Further, the pool cleaning system 1 further includes a connecting device. The connecting device includes a first connector and a second connector. The first connector is disposed on the pool cleaning robot 200, and the second connector is disposed on the base station 100. The first connector and the second connector are separably connected. The first connector may be a clip, the second connector may be a clamping slot, and the first connector and the second connector are snap-fitted with each other. Alternatively, the first connector may be an electromagnetic element, the second connector may be iron or another device that can be magnetically attracted, and the first connector and the second connector are magnetically attracted to each other. Alternatively, the first connector may be a hook, the second connector may be a hook slot, and the first connector and the second connector hooked to each other.

This facilitates the separation and connection between the pool cleaning robot 200 and the base station 100.

In some embodiments of the present application, the pool cleaning robot 200 may be provided with a timing device. After running in the pool for a preset time, the pool cleaning robot 200 may autonomously connect to the base station 100. Generally, when the pool cleaning robot 200 runs in the pool for the preset time and the filtering device 220 is filled or nearly filled with garbage, the pool cleaning robot 200 is automatically connected to the base station 100 to empty the filtering device 220. This enables a higher automation level and eliminates the need for user operation.

As shown in FIG. 5 to FIG. 10, the embodiments of the present application provide a pool cleaning system 1. The pool cleaning system 1 includes a base station 100 and a pool cleaning robot 200. The base station 100 is provided with a docking port I 108. The pool cleaning robot 200 includes a robot body 210, a filtering device 220, and at least one docking port II 211. The docking port II 211 is disposed on or connected to the robot body 210. The filtering device 220 is disposed in or connected to the robot body 210 and includes a sewage accommodating space I 228. A water flow passage is formed between the docking port II 211 and the sewage accommodating space I 228 through a flow channel 229. The flow channel 229 is disposed in the robot body 210, and has one end connected to the docking port II 211, and the other end connected to the sewage accommodating space I 228. In a case where the pool cleaning robot 200 is connected to the base station 100, at least part of the docking port I 108 docks with at least one docking port II 211.

According to the pool cleaning system 1 in the embodiment of the present application, when the pool cleaning robot 200 operates in the pool, the filtering device 220 in the pool cleaning robot 200 can collect the garbage in the pool. After the filtering device 220 collects a sufficient amount of garbage, the pool cleaning robot 200 returns to the base station 100 and is connected to the base station 100. In a case where the pool cleaning robot 200 is connected to the base station 100, at least part of the docking port I 108 of the base station 100 docks with at least one docking port II 211 of the pool cleaning robot 200. This allows the docking port I 108 to be fluidly communicated with the sewage accommodating space I 228 of the filtering device 220 through the flow channel 229, and the base station 100 can then collect the garbage in the sewage accommodating space I 228, which eliminates the need for the user to manually clean the filtering device 220 of the pool cleaning robot 200, thereby reducing the burden on the user.

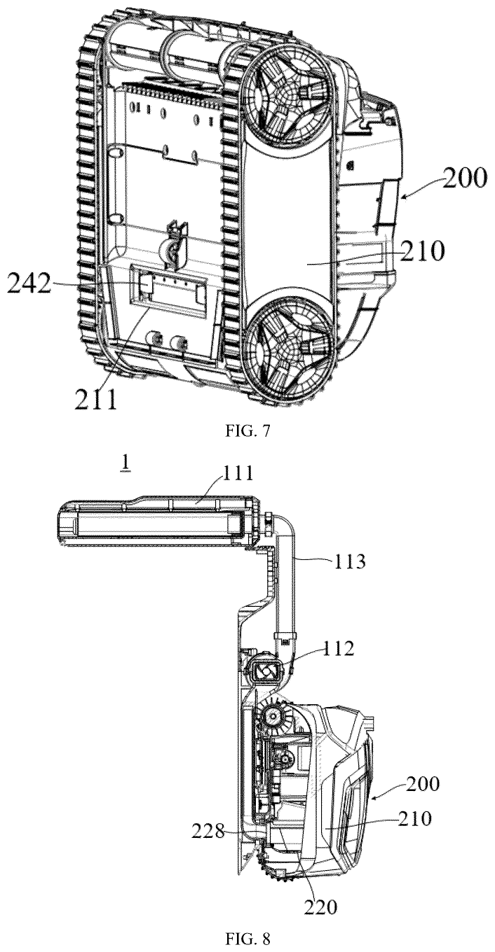

In some embodiments, as shown in FIG. 7 and FIG. 10, the pool cleaning robot 200 further includes a cover plate 240 which is disposed between the docking port II 211 and the sewage accommodating space I. A passage between the sewage accommodating space I and the docking port II 211 is closed when the cover plate 240 is at a first position. The sewage accommodating space I and the docking port II 211 are fluidly communicated when the cover plate 240 is at a second position. In a case where the pool cleaning robot 200 is connected to the base station 100, the cover plate 240 may be at the second position.

After the pool cleaning robot 200 collects a sufficient amount of garbage from the pool, the cover plate 240 may be at the first position during the movement of the pool cleaning robot 200 to the base station 100. In this way, the cover plate 240 closes the passage between the sewage accommodating space I and the docking port II 211, which can prevent the overflow of garbage in the sewage accommodating space I 228. After the pool cleaning robot 200 reaches the base station 100 and is connected to the base station 100, the cover plate 240 may be at the second position, enabling the docking port I 108 of the base station 100 to be fluidly communicated with the sewage accommodating space I 228 through the docking port II 211, thereby allowing the base station 100 to collect the garbage in the sewage accommodating space I 228.

Further, the cover plate 240 may move from the first position to the second position through at least one of the following methods:
(1) through being driven by a motor; (2) through an interaction generated by the docking between the docking port I 108 and the docking port II 211 when the pool cleaning robot 200 is connected to the base station 100; (3) through being driven by an electromagnetic device. The electromagnetic driving device may be an electromagnet, in this case, a magnet is disposed on the cover plate 240. By controlling a magnetization direction of the electromagnet, the magnet on the cover plate 240 may be attracted or repelled, providing a driving force for movement of the cover plate 240.

In some embodiments, in a case where the pool cleaning robot 200 is connected to the base station 100, at least part of the docking port I 108 is inserted into the docking port II 211, and actuates the cover plate 240 to maintain the cover plate 240 at the second position. In other words, the interaction generated by the docking between the docking port I 108 and the docking port II 211 enables the cover plate 240 to move from the first position to the second position. This method eliminates the need for additional devices to drive the cover plate 240 to move, which helps save costs and space.

In some embodiments, the cover plate 240 may move from the second position to the first position through at least one of the following methods:
(1) through an elastic force provided by an elastic element (such as a spring); (2) through being driven by a motor; or (3) through being driven by an electromagnetic device.

In some embodiments, as shown in FIG. 7 and FIG. 10, the cover plate 240 includes a plate main body 241 and at least one protrusion 242. In a case where the pool cleaning robot 200 is connected to the base station 100, the protrusion 242 is disposed on a side of the plate main body 241 close to the docking port I 108.

In a case where the pool cleaning robot 200 is connected to the base station 100, the interaction between the docking port I 108 and the protrusion 242 enables the cover plate 240 to move from the first position to the second position.

In other words, during the connection of the pool cleaning robot 200 to the base station 100, the docking port I 108 continuously applies a push force to the protrusion 242, so that the protrusion 242 drives the plate main body 241 to move until the pool cleaning robot 200 finishes its connection to the base station 100. In this case, the plate main body 241 moves to the second position, and the docking port I 108 maintains contact with the protrusion 242, ensuring that the plate main body 241 stays at the second position, so that the sewage accommodating space I and the docking port II 211 is maintained in a fluid communication state.

In an example embodiment, when reaching the second position, the cover plate 240 forms part of the flow channel 229, keeping a fluid passage between the sewage accommodating space I and the docking port II 211 unobstructed.

In some embodiments, as shown in FIG. 7 and FIG. 10, the cover plate 240 includes a plate main body 241 and at least one protrusion 242. The plate main body 241 is articulated with the docking port II 211. The plate main body 241 is configured to close or open the fluid passage between the sewage accommodating space I and the docking port II 211. The protrusion 242 is disposed on a side of the plate main body 241 close to the docking port I 108. In a case where the pool cleaning robot 200 is connected to the base station 100, the docking port I 108 actuates the protrusion 242.

During the connection of the pool cleaning robot 200 to the base station 100, the docking port I 108 continuously applies a push force to the protrusion 242, so that the protrusion 242 drives the plate main body 241 to move until the pool cleaning robot 200 finishes its connection to the base station 100. In this case, the plate main body 241 rotates to the second position.

Further, as shown in FIG. 10, the plate main body 241 is an arc plate. In a case where the pool cleaning robot 200 is connected to the base station 100, the plate main body 241 fits against a wall surface of one of flow channel walls in the flow channel 229.

In this way, in a case where the pool cleaning robot 200 is connected to the base station 100, the flow channel 229 can maintain a larger circulation area, which helps improve the efficiency of garbage collection by the base station 100.

In some embodiments, as shown in FIG. 7, the docking port II 211 is disposed on the robot body 210 or the filtering device 220. In a case where the docking port II 211 is disposed on the robot body 210, an inlet of the robot body 210 forms the docking port II 211. In a case where the docking port II 211 is disposed on the filtering device 220, an opening of the filtering device 220 forms the docking port II 211.

Further, the filtering device 220 is connected to the robot body 210, the opening of the filtering device 220 aligns with the inlet of the robot body 210, and the cover plate 240 is disposed at the opening of the filtering device 220. This arrangement enables the passage between the sewage accommodating space I and the docking port II 211 to be opened or closed by controlling the position of the cover plate 240.

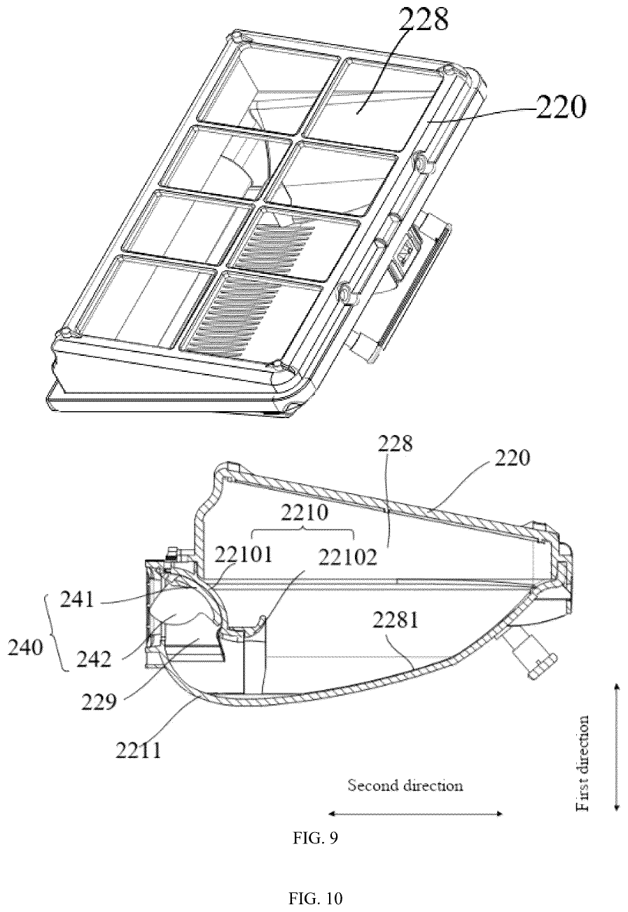

In some embodiments, as shown in FIG. 9 and FIG. 10, in a case where the pool cleaning robot 200 is connected to the base station 100, the flow channel 229 extends to the lowest position of the sewage accommodating space I.

It can be understood that when the base station 100 collects the garbage from the sewage accommodating space I, the sewage in the sewage accommodating space I needs to flow to the docking port I 108. The garbage in the filtering device 220 may accumulate at the lowest position of the sewage accommodating space I. In this embodiment, in a case where the pool cleaning robot 200 is connected to the base station 100, the flow channel 229 extends to the lowest position of the sewage accommodating space I. This arrangement enables the sewage in the sewage accommodating space I to flow to the docking port I 108 through the flow channel 229 during garbage collection, flushing the garbage into the flow channel 229 so that the garbage can enter the base station 100 through the docking port I 108.

Further, as shown in FIG. 10, the sewage accommodating space I has a slope 2281, allowing the garbage to be deposited by gravity at the inlet of the flow channel. This helps the garbage to more easily enter the flow channel 229 and then enter the base station 100 through the flow channel 229 and the docking port I 108 during garbage collection.

Further, one end of the flow channel 229 close to the lowest position of the sewage accommodating space I is provided with a flared structure. This makes it easier for the garbage at the lowest position of the sewage accommodating space I to enter the flow channel 229, and then enter the base station 100 through the flow channel 229 and the docking port I 108.

In some embodiments, as shown in FIG. 9 and FIG. 10, the flow channel 229 has a first flow channel wall 2210 and a second flow channel wall 2211 that are disposed opposite to each other in a first direction. The first flow channel wall 2210 includes a third segment 22101, and a wall surface of the third segment 22101 is a recessed arc surface. The third segment 22101 is disposed opposite to the docking port II 211 in a second direction. The first direction is perpendicular to a normal direction of a plane where the water inlet 214 is located, and the second direction is parallel to a normal direction of a plane where the docking port II 211 is located.

The flow channel 229 has the first flow channel wall 2210 and the second flow channel wall 2211 that are disposed opposite to each other in the first direction. The first flow channel wall 2210 includes the third segment 22101, and the wall surface of the third segment 22101 is the recessed arc surface. Moreover, the third segment 22101 is disposed opposite to the docking port II 211 in the second direction. This arrangement ensures that when the pool cleaning robot 200 operates in the pool, after flowing into the flow channel 229 through the docking port II 211, external water is first guided by the third segment 22101 to change its flow direction, shifting the water flow, originally directed in the second direction, toward the first direction. During the water flow direction change, the garbage carried by the water flow is also blocked by the third segment 22101, which impedes the movement of the garbage. Therefore, the garbage can be avoided from being flushed deep into the sewage accommodating space I, and can be maintained closer to the inlet of the flow channel. This makes it easier for the garbage to enter the flow channel 229 and then enter the base station 100 through the flow channel 229 and the docking port I 108 during garbage collection.

In some embodiments, as shown in FIG. 10, the first flow channel wall 2210 further includes a fourth segment 22102. The fourth segment 22102 is located at an end of the third segment 22101 away from the docking port II 211 and connected to the third segment 22101. A wall surface of the fourth segment 22102 is a protruding arc surface.

After flowing into the flow channel 229 through the docking port II 211, the external water is guided by the third segment 22101 to change its flow direction, and then guided by the second flow channel wall 2211 and the fourth segment 22102 of the first flow channel wall 2210, flowing into the sewage accommodating space I. The fourth segment 22102 is configured as the protruding arc surface, which helps improve the flow characteristics of the water flow when passing through the flow channel 229 at the inlet and reduce the probability of vortex formation, thereby improving the operating efficiency of the pool cleaning robot 200 when cleaning the pool.

In some embodiments, as shown in FIG. 10, the wall surface of the second flow channel wall 2211 is a recessed arc surface. In a case where the pool cleaning robot 200 is connected to the base station 100, the second flow channel wall 2211 is lower than the docking port II 211.

The wall surface of the second flow channel wall 2211 as the recessed arc surface can guide the water flow entering the flow channel 229 better. In addition, in a case where the pool cleaning robot 200 is connected to the base station 100, the second flow channel wall 2211 is lower than the docking port II 211 and may be positioned close to the lowest position of the sewage accommodating space I. This helps the garbage more easily enter the flow channel 229 during garbage collection.

In some embodiments, the pool cleaning system 1 further includes a water flow driving device. Under the action of the water flow driving device, the water flow can reach the docking port I 108 from the sewage accommodating space I. During the above process, the garbage in the sewage accommodating space I enters the docking port I 108 along with the water flow, and then is collected by the base station 100.

In some embodiments, the water flow is discharged out of the pool after reaching the docking port I 108. In other words, after delivering the garbage to the base station 100, the water may be discharged out of the pool, instead of being recycled into the pool.

In some embodiments, the water flow driving device includes a pump device which is disposed on the base station 100 or in the pool cleaning robot 200. In a case where the pool cleaning robot 200 is connected to the base station 100, the pump device can provide a suction force, allowing the water flow to reach the docking port I 108 from the sewage accommodating space I.

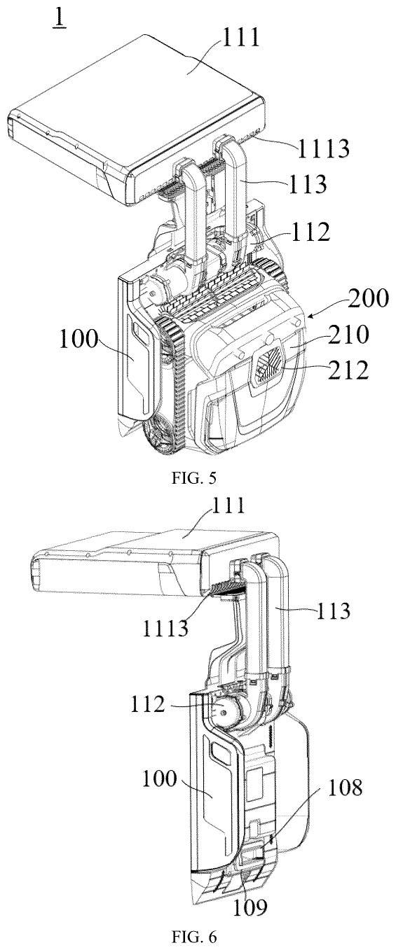

Further, as shown in FIG. 5, FIG. 6, and FIG. 8, the pump device includes at least one sewage suction pump 112. In other words, the number of the sewage suction pumps 112 may be set based on actual use requirements.

For example, the pump device includes two sewage suction pumps 112. This can improve garbage collection efficiency while also avoiding a significant increase in cost.

In some embodiments, as shown in FIG. 14, a water flow guider 1121 is disposed on the sewage suction pump 112. During the water flow passing through the sewage suction pump 112, the water flow guider 1121 may divert the garbage, making it easier for the garbage to pass through the sewage suction pump 112, thereby avoiding the garbage from being attached to an impeller of the sewage suction pump 112, which could cause the sewage suction pump 112 to get clogged.

In some embodiments, as shown in FIG. 5 and FIG. 6, the pool cleaning system 1 further includes a sewage suction pipeline 113. The sewage suction pipeline 113 communicates with the bottom of the sewage accommodating space I. Under the action of the water flow driving device, the water flow can enter the sewage suction pipeline 113 from the sewage accommodating space I through the docking port I 108. The water flow and the garbage carried by the water flow can be delivered through the sewage suction pipeline 113, allowing the water flow and the garbage to flow to the base station 100.

Further, the sewage suction pipeline 113 is configured to at least partially coincide with a central axis of the base station 100.

Further, the pump device may be disposed on the sewage suction pipeline 113. In a case where the pool cleaning robot 200 is connected to the base station 100, the pump device can provide a suction force during operating, allowing the water flow to reach the docking port I 108 from the sewage accommodating space I, and then enter the sewage suction pipeline 113.

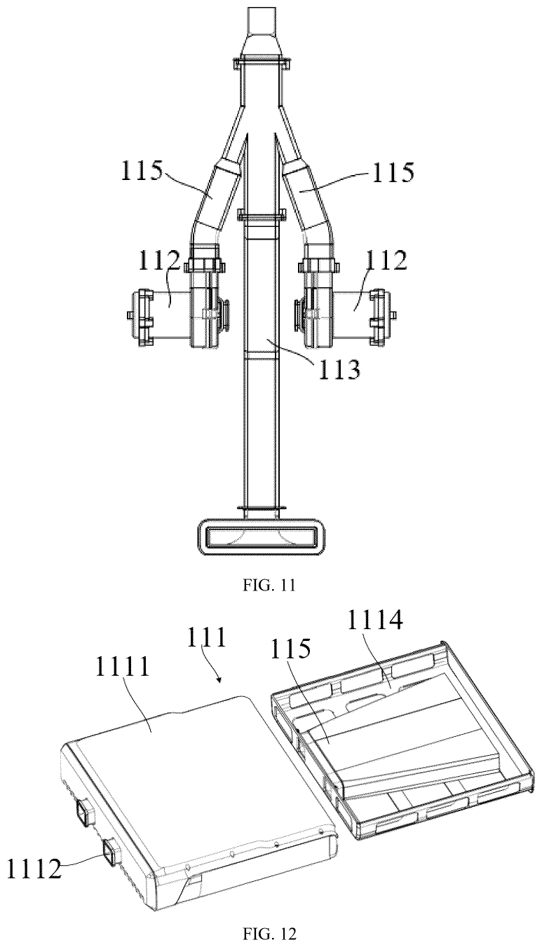

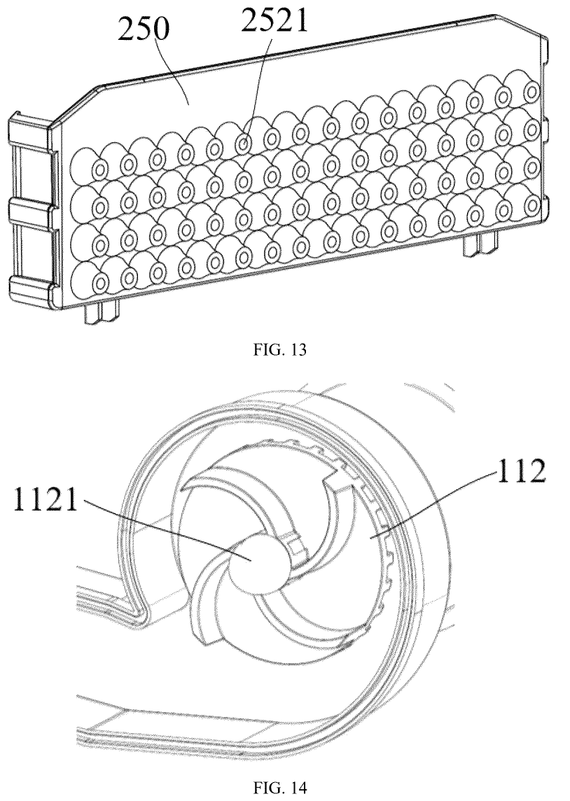

In some embodiments, the water flow driving device includes a Venturi structure. As shown in FIG. 11, for example, the pool cleaning system 1 further includes at least one connecting pipeline 115 fluidly communicated with the sewage suction pipeline 113. The Venturi structure is formed at a junction between the connecting pipeline 115 and the sewage suction pipeline 113. The pump device is disposed at the connecting pipeline 115. Under the action of the pump device, the sewage in the sewage accommodating space I is driven by the Venturi structure to flow into the sewage suction pipeline 113 from the docking port 1 108.

In this embodiment, the pump device is not directly disposed on the sewage suction pipeline 113, but is disposed on the connecting pipeline 115 connected to the sewage suction pipeline 113. When the pump device operates, a negative pressure is formed at the connection between the connection pipeline 115 and the sewage suction pipeline 113. The negative pressure provides a suction force for the sewage suction pipeline 113, allowing the water flow to enter the sewage suction pipeline 113 from the sewage accommodating space I through docking port I 108. This arrangement enables the sewage not to directly pass through the pump device, and can prevent the risk of garbage carried by the sewage accumulating at the pump device, which could cause the pump device to get clogged.

In some embodiments, the water flow driving device includes a pump device which is disposed in the pool cleaning robot 200. In other words, the pump device disposed in the pool cleaning robot 200 may also be used to provide a driving force, allowing the water flow to reach the docking port I 108 from the sewage accommodating space I.

Further, the pump device may have a first mode and a second mode. The water flow driving device, when in the first mode, drives the water flow to flow to the sewage accommodating space I from the exterior of the robot body 210, and when in the second mode, drives the water flow to flow to the docking port I 108 from the sewage accommodating space I.

When the pool cleaning robot 200 performs cleaning in the pool, the water flow driving device is in the first mode. In this mode, external water can enter the filtering device 220 for filtering, and the filtered water can be discharged through a drain port of the robot body 210. In a case where the pool cleaning robot 200 is connected to the base station 100, the water flow driving device is in the second mode, allowing the water to flow to the docking port I 108 from the sewage accommodating space I, and carrying the garbage into the docking port I 108, thereby achieving the purpose of garbage collection.

In some embodiments, as shown in FIG. 6 and FIG. 12, the base station 100 further includes a collection container 111. The collection container 111 includes a sewage accommodating space II. Under the action of the water flow driving device, the water flows to the sewage accommodating space II from the sewage accommodating space I through the docking port I 108. The collection container 111 is configured to store the garbage, meaning that the garbage carried by the water flow can be stored in the collection container 111 for centralized handling of the garbage by the user.

In some embodiments, the sewage suction pipeline 113 is disposed between the docking port I 108 and the collection container 111. Under the action of the water flow driving device, the water reaches the collection container 111 from the sewage accommodating space I through the docking port I 108 and the sewage suction pipeline 113.

In some embodiments, as shown in FIG. 12, the collection container 111 includes a container body 1111 and an accommodating device 1114. Under the action of the water flow driving device, the water flows to the container body 1111 of the collection container 111 from the docking port I 108. The accommodating device 1114 is disposed in the container body 1111 and includes the sewage accommodating space II. The accommodating device 1114 may be removed from the container body 1111.

The garbage entering the collection container 111 may accumulate in the sewage accommodating space II of the accommodating device 1114, and the accommodating device 1114 may be removed from the container body 1111, making it convenient to clean the garbage in the sewage accommodating space II.

Further, the accommodating device 1114 is an accommodating box and/or an accommodating bag. The method for removing the accommodating device 1114 from the collection container 111 includes: pulling it out or removing it through a provided flap. This makes the accommodating device 1114 easy to remove.

In some embodiments, as shown in FIG. 6 and FIG. 12, the collection container 111 further includes filtering equipment 116 and a water return structure 1113. The water in the sewage accommodating space II may be discharged from the collection container 111 through the water return structure 1113 after being filtered by the filtering equipment 116.

The filtering equipment 116 can filter the sewage entering the sewage accommodating space II, and the filtered water flows back into the pool through the water return structure 1113 of the collection container 111. This arrangement enables the collection container 111 to separate solid garbage from the sewage and collect and store only the solid garbage, while also allowing the collected water to flow back into the pool, thereby promoting the reuse of water resources.

For example, the water return structure 1113 may include a water return hole which may be provided in the container body 1111.

Further, a valve may be disposed on the filtering equipment 116. In a case where the accommodating device 1114 is installed in the container body 1111, the valve opens, and the filtering equipment 116 docks with an inlet 1112 of the container body 1111 and then is fluidly communicated with the docking port I 108. In a case where the accommodating device 1114 is separated from the container body 1111, the valve closes.

In some embodiments, the filtering equipment 116 is detachably connected to the accommodating device 1114. This makes it convenient to clean, maintain or replace the filtering equipment 116.

In some embodiments, the pool cleaning system 1 further includes a photovoltaic power generation device which is configured to supply energy to the pool cleaning system 1. The photovoltaic power generation device can convert solar energy into electric energy, for use by the pool cleaning system 1, making the pool cleaning system 1 more energy-efficient and environmentally-friendly.

In some embodiments, the pool cleaning system 1 further includes a chemical storage device, where a chemical in the chemical storage device contacts with at least part of the water flow in the pool cleaning system 1. The chemical can be used for disinfection treatment of the water flow, ensuring that the water in the pool can be cleaner after the treatment.

In some embodiments, the collection container 111 has an adjustable installation angle. This arrangement enables the collection container 111 to better adapt to different installation environments, ensuring that the collection container 111 can be stably installed in different installation environments.

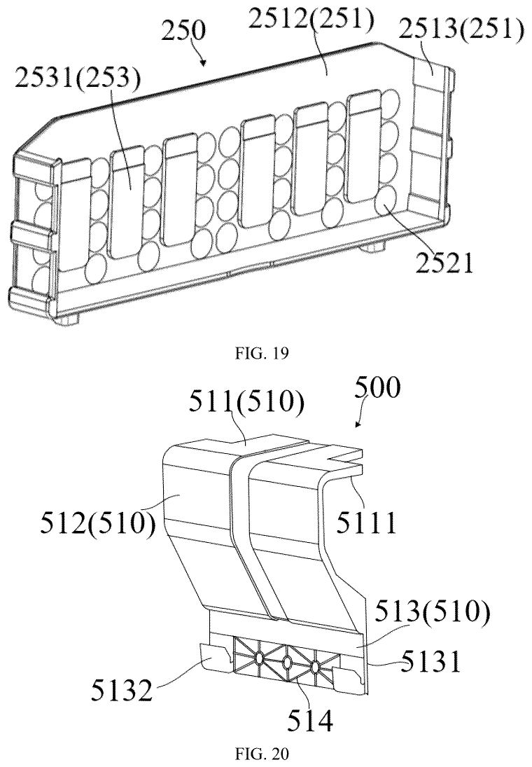

In some embodiments, as shown in FIG. 5 and FIG. 19, the robot body 210 has a robot body inlet and a robot body outlet 212. The pool cleaning robot 200 further includes a pump assembly. Under the action of the pump assembly, the water flows through the robot body inlet and the filtering device 220 and is discharged from the robot body outlet 212. The pool cleaning system 1 further includes a flushing device 250. The flushing device 250 is located between the pump assembly and the filtering device and provided with a plurality of drain holes 2521 facing the filtering device 220.

The pump assembly may have a first mode and a second mode. The pump assembly can provide a suction force. The suction force provided when the pump assembly is in the second mode is opposite in direction to the suction force provided when the pump assembly is in the first mode. When the pump assembly is in the first mode, the water flows through the robot body inlet and the filtering device 220 and is discharged from the robot body outlet 212. When the pump assembly is in the second mode, the water flows in a reverse direction and is discharged through the drain holes 2521 of the flushing device 250, thereby forming a flushing action on the filtering device 220. This flushing action helps direct the garbage in the sewage accommodating space I toward the docking port I 108. This arrangement is beneficial for more thoroughly cleaning the garbage in the filtering device 220.

It can be understood that in a case where the docking port I 108 is disposed in the robot body 210, the docking port I 108 may simultaneously serve as the robot body inlet, meaning that the docking port I 108 and the robot body inlet are the same structure.

In some embodiments, the drain holes 2521 are conical. This can increase the flow rate of the water flow ejected from the drain holes 2521, which helps improve the flushing effect on the filtering device 220.

Further, the pump assembly may include a motor and an impeller. The impeller is connected to an output shaft of the motor, and the motor can drive the impeller to rotate. By adjusting the rotation direction of the motor, the pump assembly can be switched between different modes. For example, when the motor rotates forward, the pump assembly is in the first mode, and when the motor rotates backward, the pump assembly is in the second mode.

In some embodiments, in a case where the pool cleaning robot 200 is connected to the base station 100, the docking port I 108 and the docking port II 211 are docked in a sealed manner. This can ensure the sealing of these two ports during connection, preventing water flow leakage.

In some embodiments, as shown in FIG. 6, the pool cleaning system 1 further includes a sealing element 109. The sealing element 109 is disposed around the docking port I 108 and fixed to the base station 100. When the pool cleaning robot 200 is connected to the base station 100, the sealing element 109 is compressed between the base station 100 and the robot body 210, thereby ensuring that the docking port I 108 and the docking port II 211 are docked in a sealed manner.

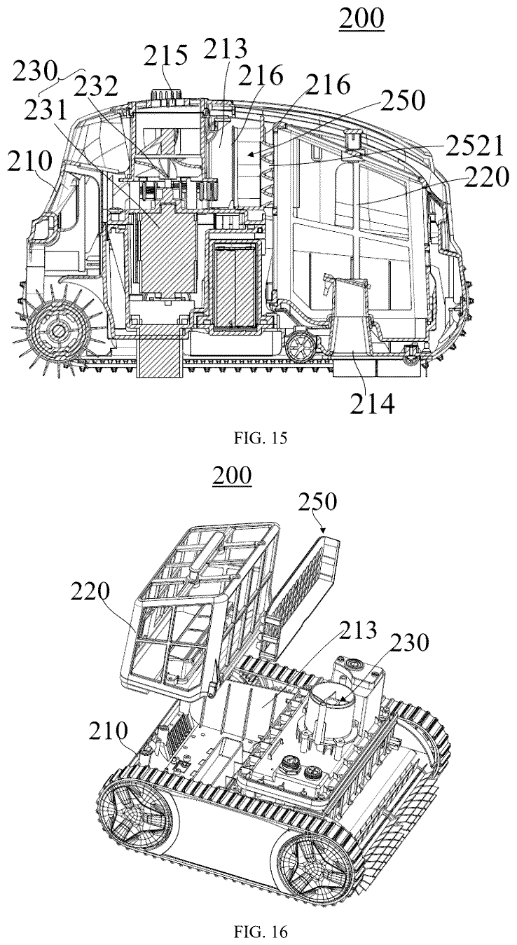

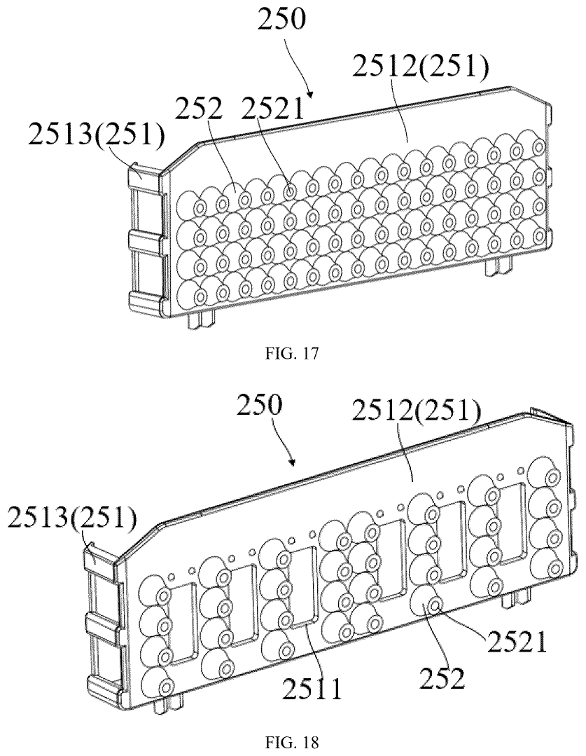

FIG. 15 is a schematic structural diagram of a pool cleaning robot according to an embodiment of the present application. FIG. 16 is a schematic exploded view of a pool cleaning robot according to an embodiment of the present application. FIG. 17 is a schematic structural diagram of a flushing device according to an embodiment of the present application. As shown in FIG. 15, FIG. 16, and FIG. 17, the pool cleaning robot 200 provided in the embodiments of the present application includes a robot body 210, a filtering device 220, a pump assembly 230, and a flushing device 250. An installation cavity 213 is disposed inside the robot body 210, and a water inlet 214 and a water outlet 215 that are fluidly communicated with the installation cavity 213 are disposed in the robot body 210. The filtering device 220 is disposed in the installation cavity 213 and is provided with a filter mesh (not shown in the drawings). The pump assembly 230 is disposed in the installation cavity 213 and has a first mode and a second mode. The pump assembly 230, when in the first mode, drives the water in the installation cavity 213 to flow to the water outlet 215 from the water inlet 214, and when in the second mode, drives the water in the installation cavity 213 to flow to the water inlet 214 from the water outlet 215. The flushing device 250 is located between the pump assembly 230 and the filtering device 220 and provided with a plurality of drain holes 2521 facing the filter mesh.

According to the pool cleaning robot 200 in the embodiment of the present application, the installation cavity 213 is disposed inside the robot body 210. The filtering device 220 and the pump assembly 230 are disposed in the installation cavity 213. The pump assembly 230, when in the first mode, can provide a suction force, allowing external water to enter the installation cavity 213 through the water inlet 214, pass through the filtering device 220 and then be discharged from the water outlet 215. This allows the pool to be cleaned.

On this basis, the flushing device 250 is further disposed in the installation cavity 213 and located between the pump assembly 230 and the filtering device 220. When in the second mode, the pump assembly 230 can provide a suction force, whose direction is opposite to the direction of the suction force provided in the first mode. Under the action of the suction force, external water enters the installation cavity 213 through the water outlet 215 and flows to the water inlet 214. During flowing in the installation cavity 213, the water flow is discharged from the drain holes 2521 of the flushing device 250, forming a flushing action on the filter mesh of the filtering device 220. This flushing action can flush away debris attached to the filter mesh, ensuring that the pool cleaning robot 200 maintains a better sewage suction capability.

Since the pool cleaning robot 200 can flush the filter mesh by adjusting the operation mode of the pump assembly 230, this method eliminates the process of disassembling and cleaning the filtering device 220 compared with the manual cleaning method for the filter mesh, thereby resulting in higher cleaning efficiency. In addition, the burden on people can also be reduced, thereby improving the user's usage experience.

As shown in FIG. 15, in some embodiments, the pump assembly 230 includes a motor 231 and an impeller 232, and an output shaft of the motor 231 is connected to the impeller 232. The rotation direction of the motor 231 when the pump assembly 230 is in the first mode is opposite to the rotation direction of the motor 231 when the pump 230 is in the second mode.

The output shaft of the motor 231 is connected to the impeller 232, and the motor 231 can drive the impeller 232 to rotate. By adjusting the rotation directions of the motor 231 and the impeller 232, the switching between the first mode and the second mode of the pump assembly 230 can be achieved. In one possible example, when the motor 231 drives the impeller 232 to rotate forward, the pump assembly 230 is in the first mode, and when the motor 231 drives the impeller 232 to rotate backward, the pump assembly 230 is in the second mode.

As shown in FIG. 15 and FIG. 17, in some embodiments, the flushing device 250 includes an installation baffle 251 and a plurality of nozzles 252 disposed on the installation baffle 251. Each of the nozzles 252 is provided with one drain hole 2521. The installation baffle 251 is located between the pump assembly 230 and the filtering device 220 and connected to the robot body 210.

The installation baffle 251 is disposed between the pump assembly 230 and the filtering device 220. The installation baffle 251 has a function of blocking the water flow, meaning that the water flow must pass through the drain holes 252 when passing through the flushing device 250. In this way, the water flow can have a higher flow rate after being discharged through the drain holes 2521, thereby improving the flushing ability on the filter mesh.

In some embodiments, each drain hole 2521 has a first aperture at one end close to the pump assembly 230 and a second aperture at one end close to the filtering device 220, where the first aperture is greater than the second aperture.

When the pump assembly 230 is in the second mode, under the action of the pump assembly 230, external water enters the installation cavity 213 through the water outlet 215, and is discharged to the filter mesh through the drain holes 2521. The first aperture at one end of each drain hole 2521 close to the pump assembly 230 is greater than the second aperture at one end of the drain hole 2521 close to the filtering device 220. Therefore, the water flow accelerates during passing through the drain hole 2521, which helps further increase the flow rate of the water flow when discharged through the drain hole 2521, and consequently, further improve the flushing ability on the filter mesh.

As shown in FIG. 17, in some embodiments, a plurality of nozzles 252 are arranged in an array. This arrangement can expand the distribution range of the nozzles 252, which can expand the flushing range of the filter mesh, and helps further improve the flushing ability on the filter mesh.

FIG. 18 is a schematic structural diagram of a flushing device according to another embodiment of the present application. FIG. 19 is a schematic structural diagram of a flushing device from another perspective according to another embodiment of the present application. As shown in FIG. 18 and FIG. 19, in some embodiments, at least one water passage hole 2511 is provided in the installation baffle 251. The flushing device 250 further includes at least one unidirectional mechanism 253 disposed at the water passage hole 2511. When the pump assembly 230 is in the first mode, the unidirectional mechanism 253 opens, allowing the water to flow through the water passage hole 2511. When the pump assembly 230 is in the second mode, the unidirectional mechanism 253 closes, blocking the water passage hole 2511.

In a case where the pump assembly 230 is in the first mode, external water enters the installation cavity 213 through the water inlet 214, passes through the filtering device 220 and is then discharged from the water outlet 215 for cleaning the pool. In the first mode, the unidirectional mechanism 253 opens, and the water passage hole 2511 in the installation baffle 251 is exposed, which can increase the flow rate of the water flow, and helps improve the cleaning efficiency of the pool cleaning robot 200. In a case where the pump assembly 230 is in the second mode, external water enters the installation cavity 213 through the water outlet 215 and flows in a reverse direction. In this case, the unidirectional mechanism 253 closes, blocking the water passage hole 2511, which allows the water to be discharged only through the drain holes 2521. This helps increase the flow rate of the water flow when discharged through the water passage hole 2521, and thereby improve the flushing ability of the water flow on the filter mesh.

As shown in FIG. 18 and FIG. 19, in some embodiments, the unidirectional mechanism 253 includes a water baffle 2531. The area of the water baffle 2531 is greater than that of the water passage hole 2511. The water baffle 2531 is located on a side of the installation baffle 251 away from the filtering device 220. The water baffle 2531 is a rubber plate or a silicone plate, and a side edge of the water baffle 2531 is connected to the installation baffle 251.

The area of the water baffle 2531 is greater than that of the water passage hole 2511, allowing the water baffle 2531 to cover the water passage hole 2511. The water baffle 2531 is located on the side of the installation baffle 251 away from the filtering device 220. In this way, when the pump assembly 230 is in the second mode, the water flow entering the installation cavity 213 through the water outlet 215 flows to the installation baffle 251. Under the action of the water flow, the water baffle 2531 can be closely attached to the installation baffle 251 and keeps covering the water passage hole 2511. Therefore, the water baffle 2531 can block the water passage hole 2511, and the water flow can be discharged only through the drain holes 2521, increasing the flow rate of the water flow when discharged through the drain holes 2521, and consequently, improving the flushing ability of the water flow on the filter mesh. In addition, since the water baffle 2531 is the rubber plate or the silicone plate, the water baffle 2531 is a soft material, ensuring that a better sealing effect can be formed when the water baffle 2531 is attached to the installation baffle 251.

When the pump assembly 230 is in the first mode, the water flow entering the installation cavity 213 through the water inlet 214 passes through the filtering device 220 and then flows to the installation baffle 251. Under the impact action of the water flow, the water baffle 2531 is separated from the installation baffle 251 and is deformed, exposing the water passage hole 2511. This allows the water to flow through the water passage hole 2511, increasing the flow rate of the water flow, thereby improving the cleaning efficiency of the pool cleaning robot 200.

As shown in FIG. 18 and FIG. 19, in some embodiments, a plurality of water passage holes 2511 are provided, and one unidirectional mechanism 253 is provided at each of the water passage holes 2511. Since the plurality of water passage holes 2511 are provided, when the pump assembly 230 is in the first mode, the water can flow through the plurality of water passage holes 2511 at the same time, which can further increase the flow rate of the water flow, thereby further improving the cleaning efficiency of the pool cleaning robot 200. In addition, each water passage hole 2511 is provided with one unidirectional mechanism 253, which ensures that when the pump assembly 230 is in the second mode, all the water passage holes 2511 can be sealed by the closed unidirectional mechanisms 253, enabling the water flow to be discharged only through the drain holes 2521.

In some embodiments, the flushing device 250 is connected to the robot body 210 in a detachable manner. This allows the flushing device 250 to be disassembled easily for inspection and maintenance on the flushing device 250.

As shown in FIG. 15, FIG. 16, and FIG. 17, in some embodiments, the flushing device 250 includes the installation baffle 251 and the plurality of nozzles 252 disposed on the installation baffle 251, where each of the nozzles 252 is provided with one drain hole 2521. The installation baffle 251 includes a baffle body 2512 and an installation portion 2513 disposed on an edge of the baffle body 2512. Limiting protrusions 216 are disposed on a side wall of the robot body 210 and define an installation groove. The installation groove extends in a height direction of the pool cleaning robot 200. The installation portion 2513 insertable into the installation groove.

A plurality of the limiting protrusions 216 may be provided, and two adjacent limiting protrusions 216 can jointly define one installation groove.

The installation baffle 251 includes a baffle body 2512 and an installation portion 2513 disposed on an edge of the baffle body 2512. The nozzles 252 are disposed on the baffle body 2512. Two installation portions 2513 may be provided and are respectively disposed on two opposite edges of the baffle body 2512. Each installation groove extends along the height direction of the pool cleaning robot 200, and each installation portion 2513 can be inserted into a corresponding installation groove. This makes the flushing device 250 detachable from the robot body 210 and makes it easy to install and operate the flushing device 250, thereby improving disassembly and assembly efficiency of the flushing device 250.

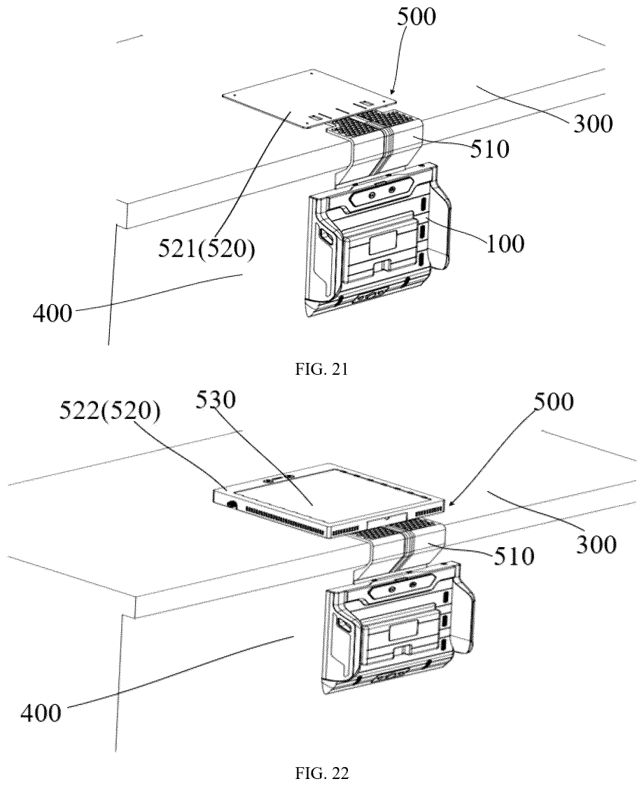

As shown in FIG. 20 and FIG. 21, a fixing device 500 in the embodiment of the present application can be used to install the base station 100 in the pool. The fixing device 500 includes a connecting member 510. The connecting member 510 has one end connected to a pool bank 300 of the pool, and the other end connected to the base station 100, enabling the base station 100 to be installed on a side wall 400 of the pool.

The pool bank 300 of the pool is a flat ground disposed around the pool, and mainly serves to allow a person to easily walk around the pool. It can be understood that the pool bank 300 is located outside the pool, and is necessarily higher than the water level in the pool.

The base station 100 can be installed in the pool by using the fixing device 500 in the embodiment of the present application. When the fixing device 500 is used, one end of the connecting member 510 is connected to the pool bank 300 of the pool, and the other end of the connecting member 510 is connected to the base station 100, enabling the base station 100 to be installed on the side wall 400 of the pool, thereby allowing the underwater cleaning robot to more easily return to a position where the base station 100 is located and connect to the base station 100. In this embodiment, the base station 100 is not directly connected to the pool, but is connected to the pool via the fixing device 500. In addition, one end of the connecting member 510 connected to the pool bank 300 is located outside the pool and is higher than the water level, ensuring that the connection strength between the fixing device 500 and the pool bank 300 is not affected by water. Therefore, this installation method can enhance the installation firmness of the base station 100, thereby reducing the risk of falling of the base station 100.

In some embodiments, the connecting member 510 includes a first connecting portion 511, an extension portion 512, and a second connecting portion 513 that are connected in sequence. The first connecting portion 511 is configured to connect to the pool bank 300 of the pool, and the second connecting portion 513 is configured to connect to the base station 100, enabling the base station 100 to be installed on the side wall 400 of the pool.

The connecting member 510 has the first connecting portion 511, the extension portion 512, and the second connecting portion 513, each portion serving a distinct function. The first connecting portion 511 is mainly configured to connect to the pool bank 300, the second connection portion 513 is mainly configured to connect to the base station 100, and the extension portion 512 is mainly configured to connect the first connecting portion 511 and the second connecting portion 513. The connecting member 510 may be of an integrated structure, or a split structure. In the latter case, the first connecting portion 511, the extension portion 512, and the second connecting portion 513 may be separately fabricated and then connected together using a screw, a rivet, an adhesive or other methods.

In some embodiments, the first connecting portion 511 has a first abutting surface 5111, and the second connecting portion 513 has a second abutting surface 5131. In a case where the first connecting portion 511 is connected to the pool bank 300, the first abutting surface 5111 abuts against a top surface of the pool bank 300, and the second abutting surface 5131 abuts against the side wall 400 of the pool. This arrangement can improve the connection stability between the first connecting portion 511 and the pool bank 300 and the positional stability of the second connecting portion 513 relative to the side wall 400 of the pool.

In some embodiments, a plane where the first abutting surface 5111 is located is perpendicular to a plane where the second abutting surface 5131 is located. Generally, the top surface of the pool bank 300 is perpendicular to the side wall 400 of the pool. Therefore, in this embodiment, the plane where the first abutting surface 5111 is located perpendicular to the plane where the second abutting surface 5131 is located. In this way, when the first abutting surface 5111 is tightly attached to the top surface of the pool bank 300, the second abutting surface 5131 can also naturally be tightly attached to the side wall 400 of the pool, ensuring better positional stability of the first connecting portion 511 and the second connecting portion 513 relative to the pool.

In some other embodiments, the first abutting surface 5111 may not directly abut against the top surface of the pool bank 300, but may indirectly abut against the top surface of the pool bank 300. For example, a foot may be disposed at the bottom of the first abutting surface 5111 and abuts against the top surface of the pool bank 300. Similarly, the second abutting surface 5131 may also indirectly abut against the side wall 400 of the pool. For example, a foot is disposed at the bottom of the second abutting surface 5131 and abuts against the side wall 400 of the pool.

In some embodiments, at least one bending structure is formed on the extension portion 512. In some pools, a horizontally extending boss may be formed at the edge of the pool bank 300 and protrudes from the side wall 400 of the pool, forming a structure similar to an “eave”. By forming the at least one bending structure on the extension portion 512, the extension portion 512 is in a bending shape as a whole, making it better suited to a pool with a boss disposed at the edge of the pool bank 300, thereby allowing the second abutting surface 5131 of the second connecting portion 513 to abut against the side wall 400 of the pool.

Further, the bending structure has an adjustable bending angle. When the bending angle of the bending structure changes, the overall shape of the extension portion 512 also changes, allowing the extension portion 512 to be more flexibly adjusted to fit different pools.

In some embodiments, as shown in FIG. 20, the second connecting portion 513 is provided with hooks 5132. The hooks 5132 are configured to hang the base station 100, meaning that the base station 100 may be connected to the second connecting portion 513 in a hanging manner. When the base station 100 is connected to the second connecting portion 513 in a hanging manner, the gravity of the base station 100 itself can help maintain a more stable connection between the base station 100 and the second connecting portion 513. In this embodiment, the connection between the base station 100 and the second connecting portion 513 in a hanging manner also provides advantages of convenience in operation, high installation efficiency and the like.

Further, at least two hooks 5132 are provided, with a gap between any two adjacent hooks 5132. For example, the number of the hooks 5132 may be two, three, four, or the like. Providing at least two hooks 5132 can improve the connection stability between the base station 100 and the second connecting portion 513. In addition, the gap between any two adjacent hooks 5132 ensures that connection points between the base station 100 and the second connecting portion 513 are relatively distributed, which helps further improve the connection stability between the base station 100 and the second connecting portion 513.

In some other embodiments, the second connecting portion 513 may also be connected to the base station 100 using a screw, a rivet, a clip, or the like, thereby achieving a stable connection between the base station 100 and the second connecting portion 513.

In some embodiments, the first connecting portion 511 is fixed to the pool bank 300 via a bolt, or an adhesive, or a suction cup. In this embodiment, the first connecting portion 511 is directly fixed to the pool bank 300. In actual applications, connection may realized via the bolt, the adhesive, or the suction cup. It can be understood that, since the first connecting portion 511 is located outside the pool and is higher than the water level, a stable connection between the first connecting portion 511 and the pool bank 300 can be achieved even using the adhesive, meaning that the bonding strength will not be affected by water.

In some embodiments, the connecting member 510 is an engineering plastic part. The engineering plastic part has better structural strength and rigidity while also being relatively lightweight. Therefore, using the engineering plastic part for the connecting member 510 helps reduce the overall weight of the fixing device 500, making the fixing device 500 easier to transport. In some other embodiments, the connecting member 510 may also be a metal part, such as stainless steel or aluminum alloy, so that it can have better structural strength and rigidity.

In some other embodiments, as shown in FIG. 21, the fixing device 500 further includes a counterweight assembly 520. The first connecting portion 511 is connected to the counterweight assembly 520. The counterweight assembly 520 is configured to be fixed to the pool bank 300. In this embodiment, the first connecting portion 511 is fixed to the pool bank 300 using the counterweight assembly 520, meaning that the first connecting portion 511 is indirectly connected to the pool bank 300. It can be understood that the counterweight assembly 520 has a relatively large weight. The counterweight assembly 520, in a case of being fixed to the pool bank 300, can have better positional stability. Even if the connection strength in the connection between the counterweight assembly 520 and the pool bank 300 is insufficient, the positional stability of the counterweight assembly 520 can also be improved by its own weight, ensuring that the counterweight assembly 520 will not shift.

In actual applications, the counterweight assembly 520 may be connected to the pool bank 300 using bolts, resulting in a higher connection strength between the counterweight assembly 520 and the pool bank 300.

In some embodiments, as shown in FIG. 21, the counterweight assembly 520 includes a counterweight plate 521. The counterweight plate 521 may be a metal plate, and metal has a high density. By using the metal plate, the counterweight plate 521 can obtain a larger weight with the same volume. Certainly, the counterweight plate 521 may be a cement plate, a stone plate or any other structure with a larger weight.

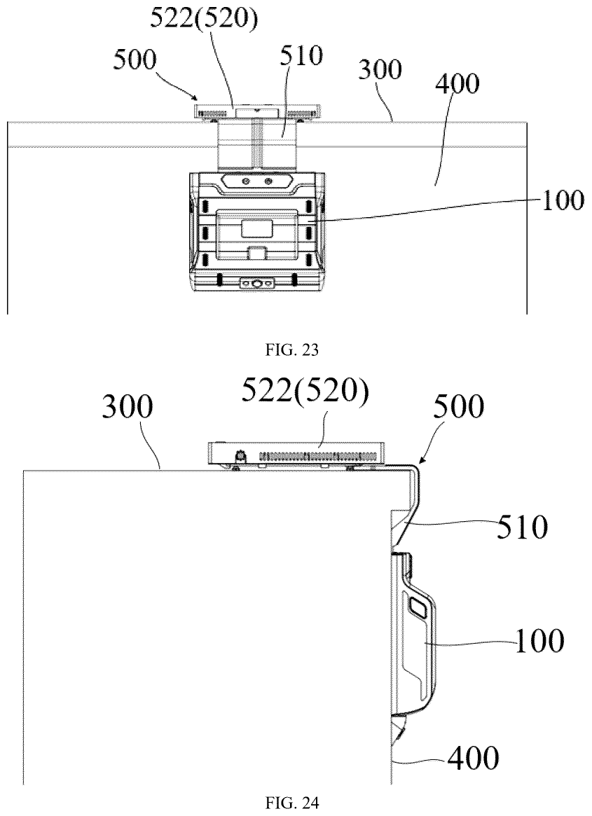

In another embodiment, as shown in FIG. 22, FIG. 23, and FIG. 24, the counterweight assembly 520 includes a counterweight plate 521 and an outer shell 522, where the counterweight plate 521 is installed in the outer shell 522.

The outer shell 522 can play a role in protecting the counterweight plate 521. For example, the outer shell 522 prevents a collision between an external object and the counterweight plate 521. For another example, when the counterweight plate 521 is a metal plate, the outer shell 522 can provide a waterproof effect on the metal plate to prevent the metal plate from rusting due to contact with water.

In actual applications, the outer shell 522 may be an engineering plastic part, which has better structural strength and rigidity, ensuring a better protection function.

In some embodiments, as shown in FIG. 22 and FIG. 25, the fixing device 500 further includes a solar panel 530 which is fixed to the top of the counterweight plate 521. A light receiving surface of the solar panel 530 is exposed on the outer shell 522, and the solar panel 530 is configured to supply power to the base station 100. The solar panel 530 is also referred to as a solar cell panel or a photovoltaic cell panel, and is a device that can convert light energy into electric energy through a photoelectric effect or a photochemical effect. In this embodiment, the fixing device 500 further includes a solar panel 530 fixed to the counterweight plate 521. In addition, the light receiving surface of the solar panel 530 is exposed on the outer shell 522, making it more convenient to use the solar panel 530 to supply power to the base station 100.

In actual applications, the solar panel 530 is provided with an electrical port, and a cable of the base station 100 may be connected to the electrical port, allowing the base station 100 to be electrically connected to the solar panel 530, thereby enabling the solar panel 530 to supply power to the base station 100.

In some other embodiments, the base station 100 may also be directly connected to an alternating current power supply via cables, allowing the base station 100 to be powered via the alternating current power supply.

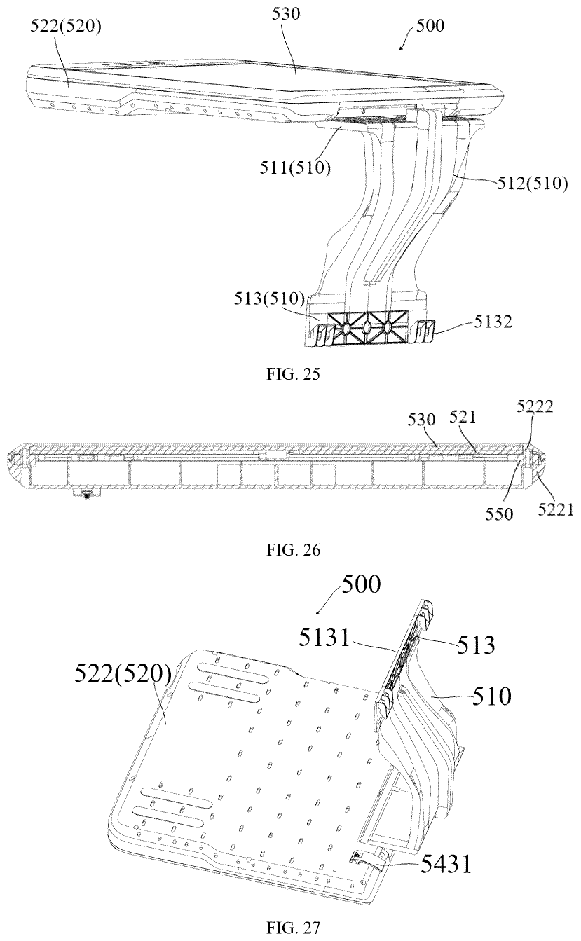

In some embodiments, as shown in FIG. 25 and FIG. 26, the outer shell 522 includes a bottom shell 5221 and an upper shell 5222 connected to the bottom shell 5221. The solar panel 530 abuts against the upper shell 5221, and an elastic element 550 is disposed between the counterweight plate 521 and the bottom shell 5222. During assembly, the solar panel 530 may be connected to the counterweight plate 521 first, and then the upper shell 5222 and the bottom shell 5221 are used to enclose the solar panel 530 and the counterweight plate 521 between them. Since installation errors might be present when the solar panel 530 is connected to the counterweight plate 521, the elastic element 550 is disposed between the counterweight plate 521 and the bottom shell 5222. The elastic element 550 provides a support force for the counterweight plate 521, and the solar panel 530 abuts against the upper shell 5222, so that the solar panel 530 and the counterweight plate 521 can be fixed between the upper shell 5222 and the bottom shell 5221. In addition, the elastic element 550 may generate adaptive deformation to account for the installation errors between the solar panel 530 and the counterweight plate 521.

In actual applications, the elastic element 550 is, for example, a rubber block, a silicone block, a spring, or the like.

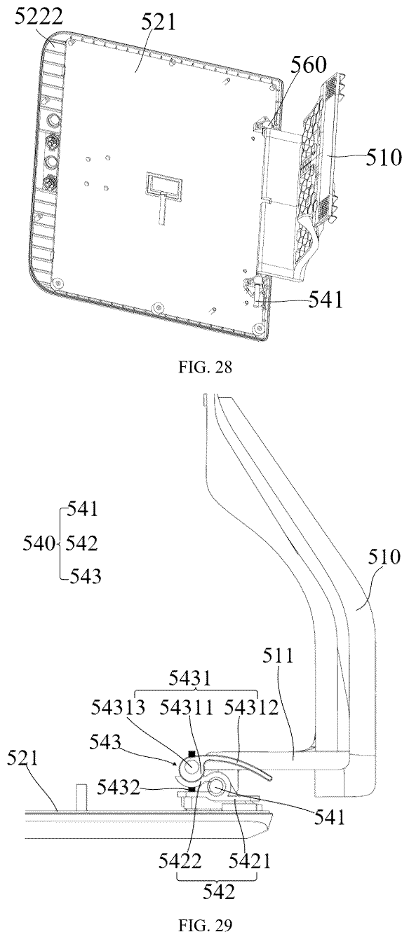

In some embodiments, as shown in FIG. 27, FIG. 28, and FIG. 29, the second connecting portion 513 has a second abutting surface 5131. The first connecting portion 511 is connected to the counterweight plate 521 via a connecting shaft assembly 540. The connecting shaft assembly 540 is configured to adjust an angle between the second abutting surface 5131 and the counterweight plate 521.

Therefore, in a case where the first connecting portion 511 is fixed to the pool bank 300 via the counterweight assembly 520, an angle between the second abutting surface 5131 and a vertical direction can be more flexibly adjusted using the connecting shaft assembly 540. For example, the second abutting surface 5131 may be adjusted to be parallel to the side wall 400 of the pool, or to be inclined relative to the side wall 400.

Further, the connecting shaft assembly 540 includes a rotating shaft 541, a shaft seat 542, and an adjusting member 543. One of the first connecting portion 511 and the counterweight plate 521 is fixed to the rotating shaft 541, and the other one of the first connecting portion 511 and the counterweight plate 521 is fixed to the shaft seat 542. The shaft seat 542 includes a seat body 5421 and an elastic arm 5422 connected to the seat body 5421. The elastic arm 5422 and the seat body 5421 jointly define an accommodating groove. The rotating shaft 541 fits in the accommodating groove. The adjusting member 543 abuts against the elastic arm 5422 and is configured to adjust the pressure between the elastic arm 5422 and the rotating shaft 541.

When the angle between the second abutting surface 5131 and the vertical direction needs to be adjusted, the adjusting member 543 can be used to release a pressing action on the elastic arm 5422, allowing the elastic arm 5422 to no longer press against the rotating shaft 541. This enables the rotating shaft 541 to rotate relative to the seat body 5421, thereby changing the angle between the second abutting surface 5131 and the vertical direction. After the adjustment is complete, the adjusting member 543 can press against the elastic arm 5422 again, enabling the elastic arm 5422 to press against the rotating shaft 541. This ensures that the rotating shaft 541 remains fixed relative to the seat body 5421, keeping the angle between the second abutting surface 5131 and the vertical direction unchanged.

In one possible embodiment, the adjusting member 543 includes an adjusting wrench 5431 and a connecting column 5432. The connecting column 5432 is fixed to the seat body 5421, and the adjusting wrench 5431 is installed on the connecting column 5432. The adjusting wrench 5431 includes a pressing portion 54311, a handle 54312, and an installation portion 54313. The installation portion 54313 is connected to an installation column 5432, the pressing portion 54311 is rotatably connected to the installation portion 54313, and the handle 54312 is fixedly connected to the pressing portion 54311. This can allow the handle 54312 to drive the pressing portion 54311 to rotate. Moreover, during rotation of the pressing portion 54311, a pressing force between the pressing portion 54311 and the elastic arm 5422 changes.

In some embodiments, the first connecting portion 511 is further connected to the counterweight plate 521 via an articulated shaft 560, and a central axis of the articulated shaft 560 coincides with that of the rotating shaft 541. This arrangement can improve the connection stability between the first connecting portion 511 and the counterweight plate 521, and ensures that the first connecting portion 511 rotates more stably relative to the counterweight plate 521 during adjustment of the angle between the second abutting surface 5131 and the vertical direction, thereby avoiding wobbling during rotation.

In some embodiments, reinforcement ribs 514 are disposed on at least one of the first connecting portion 511, the extension portion 512, and the second connecting portion 513. This can further improve the structural strength and rigidity of the connecting member 510, making it less prone to deformation or structural failure, thereby prolonging the service life of the fixing device 500.

An embodiment in a second aspect of the present application provides a pool cleaning system. The pool cleaning system includes a base station 100, a pool cleaning robot (not shown in the figure), and the fixing device 500 in any one of the above embodiments, where a connecting member 510 is connected to the base station 100.

The pool cleaning system in the embodiment of the present application is provided with the fixing device 500. The base station 100 can be installed in the pool via the fixing device 500. When the fixing device 500 is used, one end of the connecting member 510 is connected to the pool bank 300 of the pool, and the other end of the connecting member 510 is connected to the base station 100, enabling the base station 100 to be installed on the side wall 400 of the pool, thereby allowing the underwater cleaning robot to more easily return to a position where the base station 100 is located and connect to the base station 100. In this embodiment, the base station 100 is not directly connected to the pool, but is connected to the pool via the fixing device 500. In addition, one end of the connecting member 510 connected to the pool bank 300 is located outside the pool and is higher than the water level ensuring that the connection strength between the fixing device 500 and the pool bank 300 is not affected by water. Therefore, this installation method can enhance the installation firmness of the base station 100, thereby reducing the risk of falling of the base station 100.

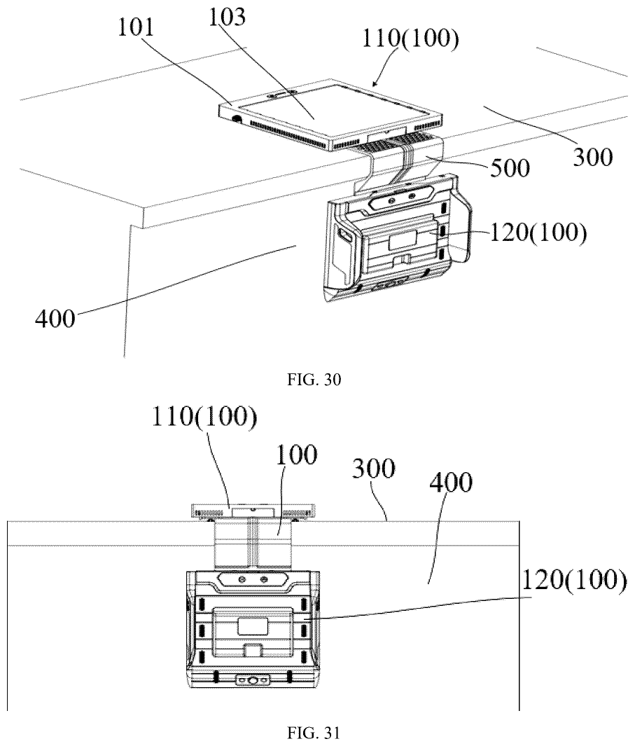

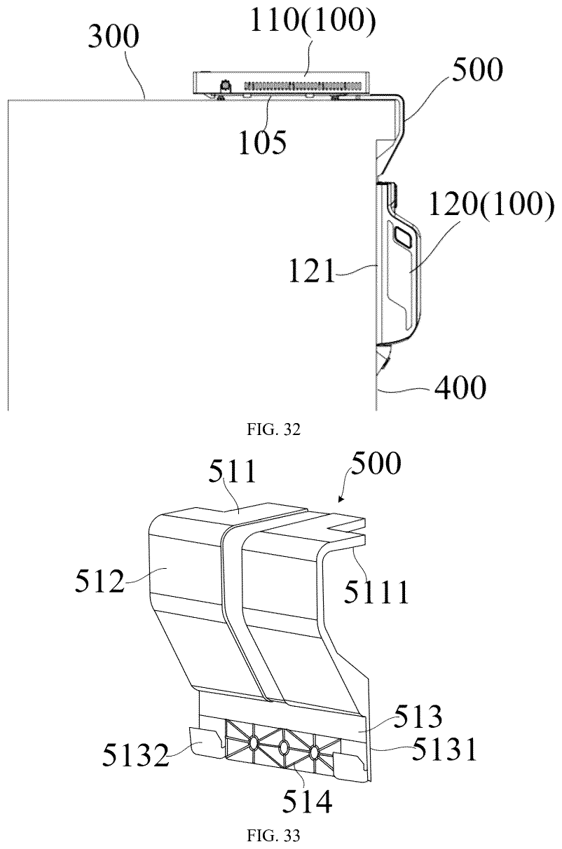

As shown in FIG. 30, FIG. 31, FIG. 32, and FIG. 40, the pool cleaning system in this embodiment of the present application includes a pool cleaning robot 200 and a base station 100. The base station 100 has a first surface 105 that abuts against or gets close to the pool bank 300 of the pool, and a second surface 121 that abuts against or gets close to the pool wall 400 of the pool. The base station 100 has a first part 110 and a second part 120. The first surface 105 is disposed on the first part 110 of the base station 100, and the second surface 121 is disposed on the second part 120 of the base station 100. The first part 110 and the second part 120 are connected via the fixing device 500. The pool cleaning robot 200 may be connected to the second part 120 of the base station 100.

The pool bank 300 of the pool is a flat ground disposed around the pool, and mainly serves to allow a person to easily walk around the pool. It can be understood that the pool bank 300 is located outside the pool, and is necessarily higher than the water level in the pool.

In the embodiment of the present application, the base station 100 has the first part 110 and the second part 120. The first part 110 and the second part 120 are connected via the fixing device 500. The second part 120 is located on the pool wall 400 of the pool, allowing the pool cleaning robot 200 to be connected to the second part 120. The first part 110 may be disposed on the pool bank 300. In a case where part of the base station 100 is disposed on the pool bank 300, the first surface 105 abuts against or gets close to the pool bank 300. This arrangement ensures that the second part 120 of the base station 100 does not need to be bonded to the pool wall 400 of the pool, and thereby helps avoiding issues of weak bonding due to water impact. In addition, the first part 110 of the base station 100 may be connected to the pool bank 300, or a part of the fixing device 500 close to the first part 110 is connected to the pool bank 300, enabling the base station 100 to be installed more stably, thereby enhancing the installation firmness of the base station 100.

In some embodiments, as shown in FIG. 32 and FIG. 33, at least one bending structure is disposed on the fixing device 500. In some pools, a horizontally extending boss may be formed at the edge of the pool bank 300 and protrudes from the pool wall 400 of the pool, forming a structure similar to an “eave”. By forming the at least one bending structure on the fixing device 500, the fixing device 500 is in a bending shape as a whole, making it better suited to a pool with a boss disposed at the edge of the pool bank 300, thereby allowing a first plane on the first part 110 of the base station 100 to abut against or get close to the pool bank 300, and a second plane on the second part 120 to abut against or get close to the pool bank 400.

Further, the bending structure has an adjustable bending angle.

It can be understood when the bending angle of the bending structure changes, the overall shape of the fixing device 500 also changes, allowing the fixing device 500 to be more flexibly adjusted to fit different pools.

In some embodiments, the fixing device 500 and the second part 120 are detachably connected, making it convenient to disassemble and assemble the second part 120 of the base station 100 for maintenance and repair.

In some embodiments, as shown in FIG. 33, the fixing device 500 is provided with at least one hook 5132. The hook 5132 is configured to hang the second part 100 of the base station 100, meaning that the fixing device 500 may be detachably connected to the second part 120 via the hook 5132.

In a case where the second part 120 is hung on the fixing device 500, the gravity of the second part 120 itself can help maintain a more stable connection between the second part and the fixing device 500. In addition, the second part 120 is connected to the fixing device 500 via the hook 5132, further providing advantages of convenience in operation, high installation efficiency, and the like.

Further, one or more hooks 5132 may be provided. In a case where a plurality of hooks 5132 are provided, a gap is formed between any two adjacent hooks 5132. For example, the number of the hooks 5132 may be one, two, three, four, or the like. When the plurality of the hooks 5132 are provided and the gap is formed between any two adjacent hooks 5132, the connection points between the second part 120 and the fixing device 500 can be relatively dispersed, which further helps improve the connection stability between the second part 120 and the second connecting portion 513.

In some other embodiments, the fixing device 500 and the second part 120 may also be connected via a screw, a rivet, a clip, or other methods, allowing for a detachable connection between the fixing device 500 and the second part 120.

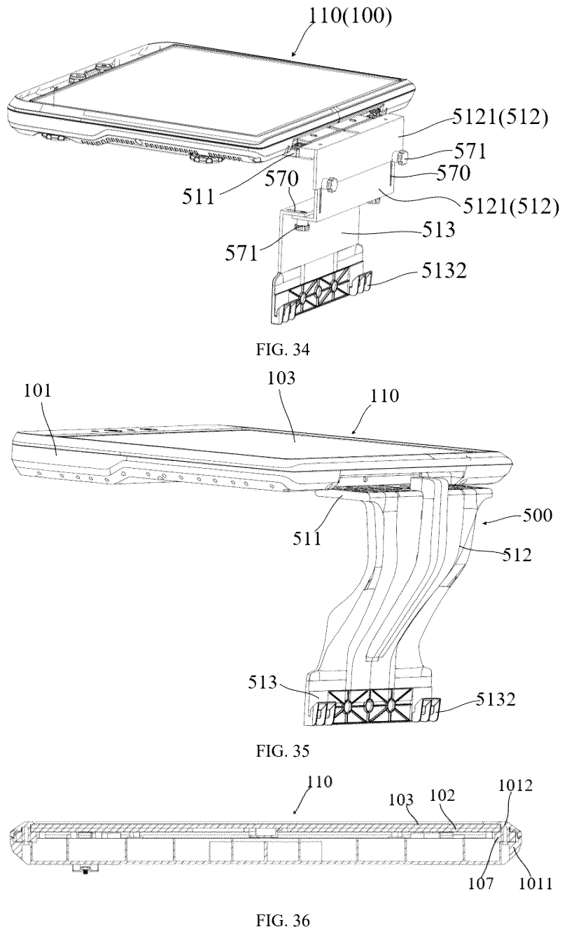

In some embodiments, as shown in FIG. 34, a distance between the fixing device 500 and the pool wall 400 is adjustable, and a distance between the fixing device 500 and the pool bank 300 is adjustable.

In actual applications, the fixing device 500 includes a first connecting portion 511, an extension portion 512, and a second connecting portion 513 that are connected in sequence. The first connecting portion 511 is connected to the first part 110 of the base station 100, and the second connecting portion 513 is configured to be connected to the second part 120 of the base station 100. The distance between the fixing device 500 and the pool wall 400 being adjustable can be understood as the distance between the second connecting portion 513 and the pool wall 400 being adjustable, and the distance between the fixing device 500 and the pool bank 300 being adjustable can be understood as the distance between the second connecting portion 513 and the pool bank 300 in the vertical direction being adjustable.

This arrangement allows for flexible adjustment of the position of the pool cleaning robot 200 according to usage needs, in a case where the pool cleaning robot 200 is connected to the base station 100.

For example, adjusting holes 570 and adjusting bolts 571 are disposed between the extension portion 512 and the second connecting portion 513, and the above adjusting holes 570 and the adjusting bolts 571 can be used to adjust the distance between the second connecting portion 513 and the pool wall 400. The extension portion 512 may include a plurality of sub-segments 5121, and the adjusting holes 570 and the adjusting bolts 571 are disposed between adjacent sub-segments 5121, allowing for adjustment of the relative positions of adjacent sub-segments 5121, thereby enabling the adjustment of the distance between the second connecting portion 513 and the pool bank 300 in the vertical direction.

In some embodiments, the angle between the fixing device 500 and the pool wall 400 is adjustable, allowing for flexible adjustment of the angle at which the pool cleaning robot 200 is connected to the base station 100.

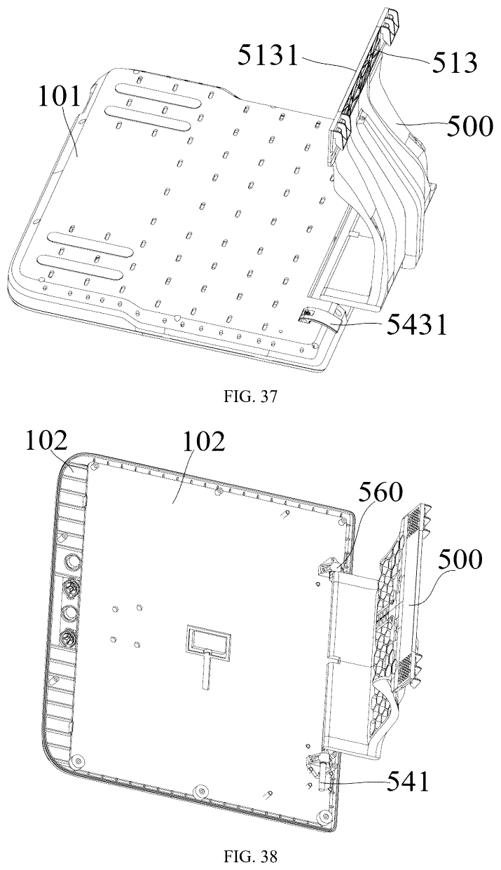

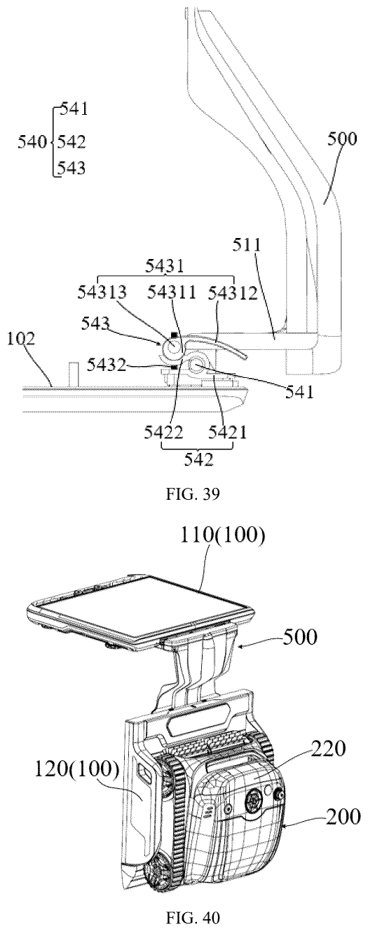

As shown in FIG. 37, FIG. 38, and FIG. 39, in some embodiments, the fixing device 500 may be connected to the first part 110 via the connecting shaft assembly 540, and the connecting shaft assembly 540 is configured to adjust the angle between the fixing device 500 and the pool wall 400.

Further, the connecting shaft assembly 540 includes a rotating shaft 541, a shaft seat 542, and an adjusting member 543. One of the fixing device 500 and the first part 110 is fixedly connected to the rotating shaft 541, and the other one of the fixing device 500 and the first part 110 is fixedly connected to the shaft seat 542. The shaft seat 542 includes a seat body 5421 and an elastic arm 5422 connected to the seat body 5421. The elastic arm 5422 and the seat body 5421 jointly define an accommodating groove. The rotating shaft 541 fits in the accommodating groove. The adjusting member 543 abuts against the elastic arm 5422 and is configured to adjust the pressure between the elastic arm 5422 and the rotating shaft 541.

When the angle between the fixing device and the pool wall 400 needs to be adjusted, the adjusting member 543 can be adjusted to release a pressing action on the elastic arm 5422, allowing the elastic arm 5422 to no longer press against the rotating shaft 541. This enables the rotating shaft 541 to rotate relative to the seat body 5421, thereby changing the angle between the fixing device 500 and the pool wall 400. After adjustment is complete, the adjusting member 543 can be used to press against the elastic arm 5422 again, enabling the elastic arm 5422 to press against the rotating shaft 541. This ensures that the rotating shaft 541 can remain fixed relative to the seat body 5421, further keeping the angle between the fixing device and the pool wall 400 unchanged.

In actual applications, the adjusting member 543 includes an adjusting wrench 5431 and a connecting column 5432. The connecting column 5432 is fixed to the seat body 5421, and the adjusting wrench 5431 is installed on the connecting column 5432. The adjusting wrench 5431 includes a pressing portion 54311, a handle 54312, and an installation portion 54313. The installation portion 54313 is connected to an installation column 5432, the pressing portion 54311 is rotatably connected to the installation portion 54313, and the handle 54312 is fixedly connected to the pressing portion 54311. This can allow the handle 54312 to drive the pressing portion 54311 to rotate. Moreover, during rotation of the pressing portion 54311, a pressing force between the pressing portion 54311 and the elastic arm 5422 changes.

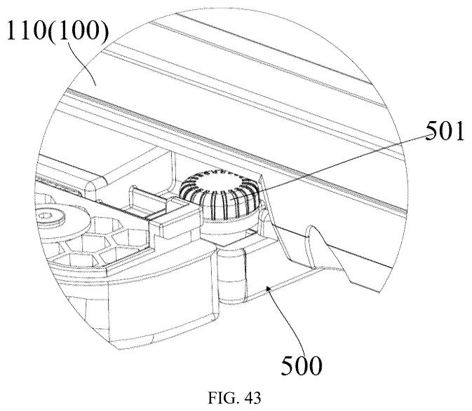

Further, the fixing device 500 is further connected to the first part 110 via an articulated shaft 560, and a central axis of the articulated shaft 560 coincides with that of the rotating shaft 541. This arrangement can improve the connection stability between the fixing device 500 and the first part 110 and helps the fixing device 500 rotate stably relative to the first part 110 during the adjustment of the angle between the fixing device 500 and the pool wall 400, thereby avoiding wobbling during rotation. As shown in FIG. 42 and FIG. 43, in another embodiment, the fixing device 500 is connected to the first part 110 in a rotatable manner (such as in an articulated manner). The fixing device 500 is provided with a limiter 501 which has an adjustable height. The limiter 501 is configured to limit the maximum angle between the fixing device 500 and the first part 110. In other words, during the rotation of the fixing device 500 relative to the first part 110, when the angle reaches its maximum value, the top of the limiter 501 abuts against the first part 110, preventing the fixing device 500 from further rotating. It can be understood that, if the height of the limiter 501 is raised, the maximum value of the angle between the fixing device 500 and the first part 110 decreases. Conversely, if the height of the limiter 501 is lowered, the maximum value of the angle between the fixing device 500 and the first part 110 increases.

For example, the limiter 501 may be a screw, and the screw is connected to a threaded hole of the fixing device 500. The height of the screw can be adjusted by rotating the screw, thereby limiting the maximum angle between the fixing device 500 and the first part 110.

In some embodiments, as shown in FIG. 33, the fixing device 500 includes a first connecting portion 511, an extension portion 512, and a second connecting portion 513 that are connected in sequence. The first connecting portion 511 is connected to the first part 110 of the base station 100, and the second connecting portion 513 is configured to be connected to the second part 120 of the base station 100. The first connecting portion 511 has a first abutting surface 5111, and the second connecting portion 513 has a second abutting surface 5131. The first abutting surface 5111 abuts against the top surface of the pool bank 300, and the second abutting surface 5131 abuts against the side wall 400 of the pool, which can improve the positional stability of the fixing device 500.

Further, the fixing device 500 may be of an integrated structure, or a split structure. In the latter case, parts of the fixing device 500 may be separately fabricated and then connected together via a screw, a rivet, an adhesive or other methods.

In some embodiments, a plane where the first abutting surface 5111 is located is perpendicular to a plane where the second abutting surface 5131 is located. Generally, the top surface of the pool bank 300 is perpendicular to the pool wall 400 of the pool. Therefore, in this embodiment, the plane where the first abutting surface 5111 is located is perpendicular to the plane where the second abutting surface 5131 is located. This ensures that when the first abutting surface 5111 is tightly attached to the top surface of the pool bank 300, the second abutting surface 5131 can also naturally be tightly attached to the pool wall 400 of the pool, ensuring better positional stability of the first connecting portion 511 and the second connecting portion 513 relative to the pool.

In some other embodiments, the first abutting surface 5111 may not directly abut against the top surface of the pool bank 300, but may indirectly abut against the top surface of the pool bank 300. For example, a foot may be disposed at the bottom of the first abutting surface 5111 and abuts against the top surface of the pool bank 300. Similarly, the second abutting surface 5131 may also indirectly abut against the pool wall 400 of the pool. For example, a foot is disposed at the bottom of the second abutting surface 5131 and abuts against the pool wall 400 of the pool.

In some embodiments, reinforcement ribs 514 are disposed on at least one of the first connecting portion 511, the extension portion 512, and the second connecting portion 513. This can further enhance the structural strength and rigidity of the fixing device 500, making it less prone to deformation and structural failure, thereby prolonging the service life of the fixing device 500.

In some embodiments, the fixing device 500 is fixed to pool bank 300 via a bolt, or an adhesive applied to the first surface 105, or a suction cup.

In actual applications, the first connecting portion 511 may be fixed to the pool bank 300 via the bolt, the adhesive, or the suction cup. It can be understood that, since the first connecting portion 511 is located outside the pool and is higher than the water level, a stable connection between the first connecting portion 511 and the pool bank 300 can be achieved even using the adhesive, meaning that the bonding strength will not be affected by water.

In some embodiments, the fixing device 500 is an engineering plastic part. The engineering plastic part has better structural strength and rigidity while also being relatively lightweight. Therefore, using the engineering plastic part for the fixing device 500 helps reduce the overall weight of the fixing device 500, making the fixing device 500 easier to transport. In some other embodiments, the fixing device 500 may also be a metal part, such as stainless steel or aluminum alloy, providing better structural strength and structural rigidity.

In some embodiments, as shown in FIG. 35 and FIG. 36, the first part 110 of the base station 100 is provided with a counterweight 102. Due to the significant weight of the counterweight 102, the first part 110 can have better positional stability relative to the pool bank 300.

Further, the counterweight 102 may be a metal plate, a cement plate, a stone plate, or the like.

In some embodiments, as shown in FIG. 35 and FIG. 36, a solar panel 103 is disposed on the counterweight 102 and configured to supply power to the base station 100. The solar panel 103 is also referred to as a solar cell panel or a photovoltaic cell panel, and is a device that can convert light energy into electric energy using a photoelectric effect or a photochemical effect. In this embodiment, the solar panel 103 is disposed on the counterweight 102, making it more convenient to use the solar panel 103 to supply power to the base station 100.

In actual applications, the solar panel 103 is provided with an electrical port, and a cable of the base station 100 may be connected to the electrical port, allowing the base station 100 to be electrically connected to the solar panel 103, thereby enabling the solar panel 103 to supply power to the base station 100.

In some other embodiments, the base station 100 may also be directly connected to an alternating current power supply via cables, allowing the base station 100 to be powered via the alternating current power supply.

In some embodiments, as shown in FIG. 35 and FIG. 36, the first part 110 of the base station 100 may include an outer shell 101, and the counterweight 102 is located inside the outer shell 101. The outer shell 101 includes a bottom shell 1011 and an upper shell 1012 connected to the bottom shell 1011. The solar panel 103 abuts against the upper shell 1021, and an elastic element 107 is disposed between the counterweight 102 and the bottom shell 1011. During assembly, the solar panel 103 may be connected to the counterweight 102 first, and then the upper shell 1012 and the bottom shell 1011 are used to enclose the solar panel 103 and the counterweight 102 between them. Since installation errors might be present when the solar panel 103 is connected to the counterweight 102, the elastic element 107 is disposed between the counterweight 102 and the bottom shell 1011. The elastic element 150 provides a support force for the counterweight 102, and the solar panel 103 abuts against the upper shell 1012, so that the solar panel 103 and the counterweight 102 can be fixed between the upper shell 1012 and the bottom shell 1011. In addition, the elastic element 150 may generate adaptive deformation to account for the installation errors between the solar panel 103 and the counterweight 102.

In actual applications, the elastic element 107 is, for example, a rubber block, a silicone block, a spring, or the like.

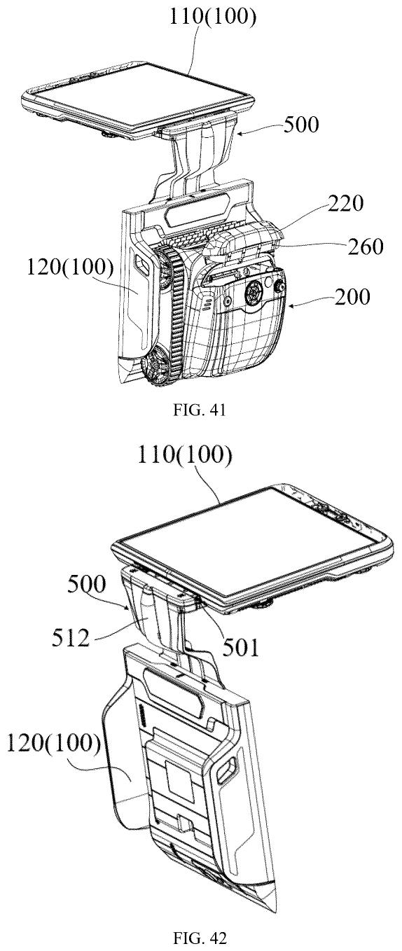

In some embodiments, as shown in FIG. 40 and FIG. 41, the pool cleaning robot 200 includes a filtering device 220 and a locking mechanism 260. In a case where the pool cleaning robot 200 docks with the base station 100, the filtering device 220 may be taken out at the pool bank 300 by unlocking the locking mechanism 260. For example, the locking mechanism 260 is an elastic clip.

This makes it convenient to take out the filtering device 220 from the pool cleaning robot 200 for cleaning the filtering device 220, and also convenient to re-install the filtering device 220 back into the pool cleaning robot 200 after cleaning.

Further, the position of the locking mechanism 260 is configured to allow the locking mechanism 260 to be unlocked or locked only manually at the pool bank 300.

In some embodiments, in a case where the pool cleaning robot 200 docks with the base station 100, the distance between the locking mechanism 260 and the pool bank 300 in the vertical direction does not exceed 50 cm. This allows a person on the pool bank 300 to reach the locking mechanism 260 of the pool cleaning robot 200 while bending over, facilitating the operation of unlocking or locking the locking mechanism 260.

In some embodiments, the pool cleaning system further includes at least one of a water quality detection system or a chemical dispensing system. When the pool cleaning system docks with the base station, the water quality detection system is located underwater. The water quality detection system includes at least one of pH detection, temperature detection, or turbidity detection. The chemical dispensing system is in contact with the water flow in the base station.

This arrangement enables the pool cleaning system to detect the water quality of the pool, and dispense a chemical based on a detection result, ensuring that the pool cleaning system has functions of water quality monitoring and purification.

The above embodiments are merely intended for describing the technical solutions of the present application, but not for limiting the present application. Although the present application has been described in detail with reference to the aforementioned embodiments, those skilled in the art should understand that they can still make modifications to the technical solutions described in the aforementioned embodiments or make equivalent replacements to some or all of the technical features thereof. These modifications or replacements do not depart from the essence of the corresponding technical solutions of the embodiments of the present application and should be included within the scope of the claims and the descriptions of the present application. In particular, as long as there is no structural conflict, the technical features mentioned in various embodiments can be combined in any way. The present application is not limited to the specific embodiments disclosed herein, but includes all technical solutions falling within the scope of the claims.

What is claimed is:

1. A pool cleaning system, comprising:
a base station (100) disposed on a pool wall;
a pool cleaning robot (200) capable of docking with the base station (100),
wherein the pool cleaning robot (200) is provided with a filtering device (220) and is separable from the base station (100), and in a case where the pool cleaning robot (200) is separated from the base station (100), a liquid in a pool is filtered using the filtering device (220).

2. The pool cleaning system according to claim 1, wherein at least part of the base station is located above water; the pool cleaning robot (200) is capable of docking with the base station (100) adjacent to a waterline;
in a case where the pool cleaning robot (200) is connected to the base station (100), the pool cleaning robot (200) is in a vertical or substantially vertical state;
the base station (100) is provided with a garbage collection device (1100); and
in a case where the pool cleaning robot (200) is connected to the base station (100), garbage in the filtering device (220) is collected into the garbage collection device (1100).

3. The pool cleaning system (1) according to claim 2, wherein the garbage collection device (1100) comprises:
a collection container (111);
a sewage suction pipeline (113), connected to the collection container (111), wherein the sewage suction pipeline (113) is fluidly communicated with the filtering device (220), in the case where the pool cleaning robot (200) is connected to the base station (100); and
a sewage suction pump (112), disposed on the sewage suction pipeline (113) and configured to suck the garbage in the filtering device (220) into the collection container (111), and/or the sewage suction pipeline (113) communicates with a bottom of the pool cleaning robot (200).

4. The pool cleaning system (1) according to claim 3, wherein the garbage collection device (1100) further comprises:
a water return passage (114), wherein a top end of the water return passage (114) is connected to the collection container (111), and the water return passage (114) is configured to discharge the liquid filtered by the collection container (111) to the pool.

5. The pool cleaning system (1) according to claim 3, wherein the base station (100) is further provided with an energy storage device (130), and the energy storage device (130) supplies power to the sewage suction pump (112).

6. The pool cleaning system (1) according to claim 5, wherein the energy storage device (130) comprises a photovoltaic charging device (131), and the photovoltaic charging device (131) is connected to the sewage suction pump (112); and
wherein, the photovoltaic charging device (131) is located above a liquid level of the pool, or at least part of the photovoltaic charging device (131) is located below the liquid level of the pool, and the part of the photovoltaic charging device (131) located below the liquid level of the pool is provided with a waterproof structure.

7. The pool cleaning system (1) according to claim 6, wherein the base station (100) is further provided with a first charging device (140), the first charging device (140) is connected to the photovoltaic charging device (131), the pool cleaning robot is provided with a second charging device (225), and in the case where the pool cleaning robot (200) is connected to the base station (100), the first charging device (140) and the second charging device (225) are connected.

8. The pool cleaning system (1) according to claim 3, wherein the pool cleaning system (1) is constructed so that:
the base station (100) is provided with a first sensor (180), the first sensor (180) is configured to detect whether the pool cleaning robot (200) is connected to the base station (100), and the sewage suction pump (112) is connected to the first sensor (180) and is started or stopped based on a signal from the first sensor (180).

9. The pool cleaning system (1) according to claim 8, wherein the base station (100) is further provided with a control panel (150) and a first signal device (160), and the control panel (150) is connected to the first signal device (160); and
the pool cleaning robot (200) is provided with a second signal device (226) and a third sensor, the third sensor is connected to the second signal device (226), the first signal device (160) and the second signal device (226) communicate with each other, the third sensor is configured to detect a volume of garbage in the filtering device (220), and the control panel (150) is configured to display the volume of the garbage in the filtering device (220);
wherein, the pool cleaning system (1) further comprises:
a connecting device, comprising a first connector and a second connector, wherein the first connector is disposed on the pool cleaning robot (200), the second connector is disposed on the base station (100), and the first connector and the second connector are separably connected; and
a controller (190), which is disposed on the base station (100) and connected to the first signal device (160), or which is disposed on the pool cleaning robot (200), connected to the third sensor and configured to control connection and separation between the first connector and the second connector based on a signal from the third sensor.

10. The pool cleaning system (1) according to claim 1, wherein the base station (100) is provided with a docking port I (108);
the pool cleaning robot (200) further comprises a robot body (210) and at least one docking port II (211), the docking port II (211) is disposed on or connected to the robot body (210), the filtering device (220) is disposed in or connected to the robot body (210) and comprises a sewage accommodating space I, a water flow passage is formed between the docking port II (211) and the sewage accommodating space I via a flow channel (229), the flow channel (229) is disposed in the robot body (210), and has one end connected to the docking port II (211) and an other end connected to the sewage accommodating space I; and
wherein, in a case where the pool cleaning robot (200) is connected to the base station (100), at least part of the docking port I (108) docks with the at least one docking port II (211).

11. The pool cleaning system (1) according to claim 10, wherein the docking port II (211) is disposed on the robot body (210) or the filtering device (220).

12. The pool cleaning system (1) according to claim 10, wherein the flow channel (229) extends to a lowest position of the sewage accommodating space I, in the case where the pool cleaning robot (200) is connected to the base station (100), the sewage accommodating space I has a slope (2281), allowing garbage to be deposited by gravity at an opening of the flow channel (229).

13. The pool cleaning system (1) according to claim 10, wherein the pool cleaning system (1) further comprises a water flow driving device; and
under an action of the water flow driving device, a water flow reaches the docking port I (108) from the sewage accommodating space I, the water flow driving device comprises a pump device, and the pump device is disposed on the base station (100) or in the pool cleaning robot (200), the pump device comprises at least one sewage suction pump (112).

14. The pool cleaning system (1) according to claim 13, wherein the pool cleaning system (1) further comprises a sewage suction pipeline (113), the sewage suction pipeline (113) communicates with a bottom of the sewage accommodating space I;
under the action of the water flow driving device, the water flow enters the sewage suction pipeline (113) from the sewage accommodating space I through the docking port I (108); and/or
the sewage suction pipeline (113) is configured to at least partially coincide with a central axis of the base station (100).

15. The pool cleaning system (1) according to claim 13, wherein the pump device has a first mode and a second mode, and the water flow driving device, when in the first mode, drives the water flow to flow to the sewage accommodating space I from an exterior of the robot body (210), and when in the second mode, drives the water flow to flow to the docking port I (108) from the sewage accommodating space I.

16. The pool cleaning system (1) according to claim 13, wherein the base station (100) further comprises a collection container (111), and the collection container (111) comprises a sewage accommodating space II; and
under the action of the water flow driving device, the water flow reaches the sewage accommodating space II from the sewage accommodating space I through the docking port I (108).

17. The pool cleaning system (1) according to claim 16, wherein the sewage suction pipeline (113) is disposed between the docking port I (108) and the collection container (111); and
under the action of the water flow driving device, the water flow reaches the collection container (111) from the sewage accommodating space I through the docking port I (108) and the sewage suction pipeline (113).

18. The pool cleaning system (1) according to claim 16, wherein the collection container (111) comprises:
a container body (1111), wherein under the action of the water flow driving device, the water flow reaches the container body (1111) of the collection container (111) from the docking port I (108); and
an accommodating device (1114), disposed in the container body (1111) and comprising the sewage accommodating space II, wherein
the accommodating device (1114) is removable from the container body (1111).

19. The pool cleaning system (1) according to claim 10, wherein the pool cleaning system (1) further comprises a photovoltaic power generation device and/or a chemical storage device;
the photovoltaic power generation device supplies power to the pool cleaning system (1); and
a chemical in the chemical storage device contacts with at least part of a water flow in the pool cleaning system (1).

20. The pool cleaning system (1) according to claim 16, wherein the collection container (111) has an adjustable installation angle.

21. The pool cleaning system (1) according to claim 10, wherein the docking port I (108) and the docking port II (211) are docked in a sealed manner, in a case where the pool cleaning robot (200) is connected to the base station (100), the pool cleaning system (1) further comprises a sealing element (109), the sealing element (109) being disposed around the docking port I (108) and fixed to the base station (100); and
when the pool cleaning robot (200) is connected to the base station (100), the sealing element (109) is compressed between the base station (100) and the robot body (210).

22. The pool cleaning system (1) according to claim 1, wherein the pool cleaning robot (200) further comprises:
a robot body (210), wherein an installation cavity (213) is disposed inside the robot body (210), and a water inlet (214) and a water outlet (215) that are fluidly communicated with the installation cavity (213) are disposed in the robot body (210); wherein the filtering device (220) is disposed in the installation cavity (213) and is provided with a filter mesh; and
a pump assembly (230), wherein the pump assembly (230) is disposed in the installation cavity (213) and has a first mode and a second mode, and the pump assembly (230), when in the first mode, drives water in the installation cavity (213) to flow to the water outlet (215) from the water inlet (214), and when in the second mode, drives the water in the installation cavity (213) to flow to the water inlet (214) from the water outlet (215).

23. The pool cleaning system according to claim 1, wherein the base station (100) has a first surface (105) that abuts against or gets close to a pool bank (300), and a second surface (121) that abuts against or gets close to the pool wall;
the base station (100) has a first part (110) and a second part (120), the first surface (105) is disposed on the first part (110), the second surface (121) is disposed on the second part (120), and the first part (110) and the second part (120) are connected via a fixing device (500); and
the pool cleaning robot (200) is connectable to the second part (120) of the base station (100).

24. The pool cleaning system according to claim 23, wherein at least one bending structure is disposed on the fixing device (500); and
the bending structure has an adjustable bending angle; and/or
the fixing device (500) and the second part (120) are detachably connected by a means including a hook (5132), a screw, or a rivet.

25. The pool cleaning system according to claim 23, wherein a distance between the fixing device (500) and the pool wall is adjustable, a distance between the fixing device (500) and the pool bank (300) is adjustable; and/or an angle between the fixing device (500) and the pool wall is adjustable; and
the fixing device (500) comprises a first connecting portion (511), an extension portion (512), and a second connecting portion (513) that are connected in sequence, the first connecting portion (511) is connected to the first part (110) of the base station (100), and the second connecting portion (513) is connected to the second part (120) of the base station (100); and a distance between the second connecting portion (513) and the pool wall is adjustable, and a distance between the second connecting portion (513) and the pool bank (300) in a vertical direction is adjustable.

26. The pool cleaning system according to claim 23, wherein the first part (110) is provided with a counterweight (112); and
a solar panel (103) is disposed on the counterweight (102) and is configured to supply power to the base station (100).

27. The pool cleaning system according to claim 23, wherein the pool cleaning robot (200) comprises a filtering device (220) and a locking mechanism (260); and
in a case where the pool cleaning robot (200) docks with the base station (100), the filtering device (220) is removable at the pool bank (300) by unlocking the locking mechanism (260).

28. The pool cleaning system according to claim 27, wherein a position of the locking mechanism (260) is configured to allow the locking mechanism (260) to be unlocked or locked only manually at the pool bank (300); and/or
a distance between the locking mechanism (260) and the pool bank (300) in a vertical direction does not exceed 50 cm, in a case where the pool cleaning robot (200) docks with the base station (100).

29. The pool cleaning system according to claim 23, wherein the pool cleaning system further comprises at least one of a water quality detection system or a chemical dispensing system;
when the pool cleaning system docks with the base station (100), the water quality detection system is located underwater; and the water quality detection system comprises at least one of pH detection, temperature detection, or turbidity detection; and
the chemical dispensing system contacts with a water flow in the base station (100).

30. The pool cleaning system according to claim 23, wherein the fixing device (500) is fixed to the pool bank (300) via a bolt, or an adhesive applied to the first surface (105), or a suction cup.
